(19) United States
(12) Patent Application Publication
(10) Pub. No.: US 2025/0314591 A1
(43) Pub. Date: Oct. 9, 2025

(54) MULTIPLEX PHOTONIC BIOSENSOR APPARATUS, SYSTEM, AND METHODS

(71) Applicant: University of Rochester, Rochester, NY (US)

(72) Inventors: Benjamin L. Miller, Rochester, NY (US); Michael R. Bryan, Rochester, NY (US); Daniel Steiner, Rochester, NY (US)

(21) Appl. No.: 18/865,135

(22) PCT Filed: May 12, 2023
(86) PCT No.: PCT/US23/66909

§ 371 Date: Nov. 12, 2024

Related U.S. Application Data
(60) Provisional application No. 63/341,586, filed on May 13, 2022.

(51) Int. Cl. G01N 21/77; G01N 21/552; G01N 21/64; G01N 21/65

(52) U.S. Cl. CPC G01N 21/7703; G01N 21/553; G01N 21/648; G01N 21/65; G01N 2021/7776; G01N 2021/7779; G01N 2021/7786

(57) ABSTRACT

A photonic biosensor apparatus comprises a sample addition zone in fluid communication with a wicking zone and a sample detection zone, at least one optical input port disposed within the sample detection zone, wherein the optical input port is configured to optically couple to a light source, at least one optical output port disposed within the sample detection zone, wherein the optical output port is configured to optically couple to a photodetector via a fiber bundle, at least one photonic integrated circuit (PIC) disposed directly atop a substrate, wherein the at least one photonic integrated circuit comprises at least one first grating coupler aligned with the optical input port, at least two second grating couplers aligned with the optical output port, at least one waveguide between the first grating coupler and the second grating couplers, and at least one detection element disposed within the at least one waveguide.

### CROSS-REFERENCE TO RELATED APPLICATIONS

This application claims priority to U.S. provisional application No. 63/341,586 filed on May 13, 2022, incorporated herein by reference in its entirety.

### STATEMENT REGARDING FEDERALLY SPONSORED RESEARCH OR DEVELOPMENT

This invention was made with government support under FA8650-15-2-5220 awarded by the Department of Defense. The government has certain rights in the invention.

### BACKGROUND OF THE INVENTION

The use of photonic biosensors to measure refractive light index changes in a sample is well known. The detected change in refractive light of a sample provides for the detection of analytes. Some known optical structures of a biosensor cause a refractive index change as a result of binding of an analyte to an optical surface and/or reagent, which creates a detectable change in an optical resonance frequency. These known biosensors provide high sensitivity and label free detection of desired analytes.

Typically, detection elements of biosensors are created on silicon substrates using traditional silicon-based nanoscale manufacturing processes, such as complementary metal-oxide-semiconductor (“CMOS”) fabrication processes. The use of silicon-based fabrication processes creates biosensor detection elements for integrated photonics that have exceptional optical and biochemical characteristics. For example, silicon-based fabrication processes enable precise and/or intricate optical structures of a detection element to be manufactured in silicon or silicon nitride. The optical structures include, for instance, ring resonators, spiral waveguides, grating couplers, and Mach-Zehnder Interferometers (“MZI”). These structures generally require near defect-free optical paths to ensure results are not affected by material impurities or structure defects.

While silicon-based processes provide precise biosensor detection elements on a substrate, known biosensors typically have costly fluid and light interconnections. For example, optical fiber bonding of input and output optics is typically needed for interfacing with light paths of a detection element. Further, many biosensors have complex active fluid delivery mechanisms to bring a sample into contact with the detection element. Oftentimes, a fluid sample is pulled or pushed to a detection element using external pumps that control sample volume and flow rate through the biosensor. This light and fluid interconnect complexity increases the cost of instrumentation, and the biosensors themselves. While the increased cost may be acceptable for some medical applications, generally point-of-care (“PoC”) and mainframe laboratory diagnostic applications are cost sensitive, especially for disposable products such as a single-use biosensor example slide, cassette, membrane, fibrous substrate, or test card.

Thus, there is a need in the art for improved multiplex photonic biosensors and related methods.

### SUMMARY OF THE INVENTION

Some embodiments of the invention disclosed herein are set forth below, and any combination of these embodiments (or portions thereof) may be made to define another embodiment.

In one aspect a photonic biosensor apparatus comprises a sample addition zone in fluid communication with a wicking zone and a sample detection zone, wherein the sample detection zone is between the sample addition zone and the wicking zone, and at least one photonic integrated circuit (PIC) disposed directly on a substrate, optically coupled to a light source and a photo detector via a fiber bundle, wherein the at least one photonic integrated circuit comprising at least one first grating coupler, at least two second grating couplers, at least one waveguide between the first grating coupler and the second grating couplers, and at least one detection element disposed within the at least one waveguide.

In one embodiment, the PIC is optically couped through the substrate.

In one embodiment, the apparatus further comprises at least one optical input port disposed within the sample detection zone, wherein the optical input port is configured to optically couple to a light source, and at least one optical output port disposed within the sample detection zone, wherein the optical output port is configured to optically couple to a photodetector via a fiber bundle, wherein the at least one first grating coupler is aligned with the optical input port, and the at least two second grating couplers are aligned with the optical output port.

In one embodiment, the fiber bundle includes a plurality of individual fibers, and wherein each of the at least one second grating coupler is mapped to an individual fiber of the fiber bundle.

In one embodiment, at least one of the individual fibers of the fiber bundle comprises a multimode fiber.

In one embodiment, at least one of the individual fibers of the fiber bundle comprises a singlemode fiber.

In one embodiment, the individual fibers of the fiber bundle comprise at least one of singlemode fibers and multimode fibers.

In one embodiment, the individual fibers of the fiber bundle are positioned in a hexagonal close-packing configuration.

In one embodiment, the individual fibers of the fiber bundle are positioned in a square close-packing configuration.

In one embodiment, the PIC is configured for front-side coupling wherein the PIC is coupled to a top surface of the substrate opposite the fiber bundle.

In one embodiment, the PIC is configured for back-side coupling wherein the PIC is coupled to a bottom surface of the substrate between the substrate and the fiber bundle.

In one embodiment, the apparatus is configured to detect three or more analytes simultaneously.

In one embodiment, the substrate comprises at least one of a cassette, a slide, a membrane, a fibrous substrate, or a test card.

In one embodiment, the light source and the photodetector are included within a read head of at least one of a laboratory analyzer or a point-of-care (“PoC”) analyzer.

In one embodiment, the apparatus further comprises at least one of a fluid pathway, a paper pathway, or a membrane pathway that fluidly couples the sample addition zone, the detection zone, and the wicking zone.

In one embodiment, the fluid pathway includes micropillars or projections that are substantially vertical to the surface of the substrate and having a height between about 1 μm to 1000 μm, a diameter between about 10 μm to 100 μm, and a reciprocal spacing between the micropillars between about 5 μm to 100 μm such that lateral capillary flow of the fluid sample is achieved.

In one embodiment, the detection zone is configured to provide at least one of fluorescence, refractive index shift, Raman signal, absorbance signal, plasmonic shift or colorimetric detection of one or more analytes within the fluid sample.

In one embodiment, the photonic integrated circuit is connected to the substrate using at least one of a UV curable adhesive, physical stacking, lamination or a tape/glue application.

In another aspect, a photonic integrated circuit (PIC) comprises at least one first grating coupler, at least two second grating couplers, at least one waveguide between the first grating coupler and the second grating couplers, and at least one detection element disposed within the at least one waveguide.

In one embodiment, the at least one detection element includes at least one capture molecule.

In one embodiment, the at least one first grating coupler is aligned with an optical input port, and the at least two second grating couplers are aligned with an optical output port.

In one embodiment, the at least one detection element includes at least one of a ring resonator, a double ring resonator, a cylindrical resonator, a spherical resonator, a spiral waveguide, a Vernier filter, a photonic crystal, a Mach-Zehnder Interferometer (“MZI”), or combinations thereof.

In one embodiment, the at least one waveguide comprises a silicon nitride waveguide.

In one embodiment, the photonic integrated circuit has a rectangular prism or cuboid shape with a length between 2-20 mm, a width between 0.25-10 mm, and a height between 0.1-5 mm.

In one embodiment, the at least one waveguide splits into a plurality of branches from the first grating coupler to the at least two second grating couplers.

In one embodiment, the at least one detection element is positioned on one of the plurality of branches.

In one embodiment, the at least one detection element has an extinction ratio greater than 5 dB under aqueous cladding.

In one embodiment, each detection element has a unique extinction ratio.

In another aspect, a substrate comprises a sample addition zone in fluid communication with a wicking zone and a sample detection zone, wherein the sample detection zone is between the sample addition zone and the wicking zone, and at least one photonic integrated circuit (PIC) disposed directly on a top or bottom surface of the substrate, optically coupled to a light source and a photodetectors via a fiber bundle, wherein the at least one photonic integrated circuit comprising at least one first grating coupler, at least one second grating coupler t, at least one waveguide between the first grating coupler and the second grating coupler, and at least one detection element disposed within the at least one waveguide.

In one embodiment, the at least one detection element is positioned to contact a fluid sample within the sample detection zone.

In one embodiment, the PIC is optically coupled through the substrate.

In one embodiment, the substrate further comprises at least one optical input port disposed within the sample detection zone, wherein the optical input port is configured to optically couple to a light source, and at least one optical output port disposed within the sample detection zone, wherein the optical output port is configured to optically couple to a photodetector via a fiber bundle, wherein the at least one first grating coupler is aligned with the optical input port, and the at least two second grating couplers are aligned with the optical output port.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1A is a diagram of a photonic biosensor including a substrate (cassette, slide, membrane, fibrous substrate, or test card) and a PIC in accordance with some embodiments.

FIG. 1B is a diagram of an example micropillar layout for a fluid flow path of a biosensor in accordance with some embodiments.

FIGS. 2A and 2B show a cut-away of the exemplary substrate of FIG. 1A at a section of a sample detection zone that includes an optical input port and an optical output port in accordance with some embodiments.

FIG. 3 shows an exemplary PIC in accordance with some embodiments.

FIG. 4 shows an exemplary multiplex hub optical system in accordance with some embodiments.

FIG. 5 shows an exemplary computing environment in accordance with some embodiments.

FIGS. 6A through 6B show an exemplary experimental setup of a multiplex PIC mounted to a micropillar card in accordance with some embodiments.

FIG. 7 shows an exemplary experimental setup of a multiplex hub optical system in accordance with some embodiments.

FIGS. 8A through 8C show an example functionalization of multiplex disposable photonics PICs in accordance with some embodiments.

FIG. 9 shows details of an exemplary multiplex optical hub fiber bundle in accordance with some embodiments.

FIG. 10 shows an experimental IR micrograph of the output gratings of an exemplary PIC in accordance with some embodiments.

FIG. 11 shows a schematic representation of the multiplex optical hub photonic biosensing apparatus in accordance with some embodiments.

FIGS. 12A through 12C are experimental images showing alignment of the fiber bundle to the output gratings of multiplex PIC in accordance with some embodiments.

FIG. 13 is a plot showing experimental 4-channel spectra from properly aligned multiplex PIC in accordance with some embodiments.

FIG. 14 is a plot showing example experimental spectra in accordance with some embodiments.

FIGS. 15A through 15D are plots showing the effect of sample diluent on detection of SARS-CoV-2 and influenza A antibodies in sample from convalescent individual that tested PCR-positive for SARS-CoV-2 in accordance with some embodiments.

FIGS. 16A through 16D are plots showing SARS-CoV-2 and influenza serology from multiplex hub and ZIVA in accordance with some embodiments.

FIGS. 17A through 17B are plots showing modeling of backside coupling in accordance with some embodiments.

FIGS. 18A through 18B show an exemplary experimental PIC in accordance with some embodiments.

FIG. 19 is a plot showing a measured resonance signal from an output grating of a through-substrate grating array in accordance with some embodiments.

FIGS. 20A through 20G are plots showing measured output spectra from through-substrate coupling in accordance with some embodiments.

FIG. 21 is a plot showing C-reactive protein biosensing data for through substrate coupling for a single sensor pair in accordance with some embodiments.

FIG. 22 is a plot showing C-reactive protein biosensing data for through substrate coupling for a single sensor pair in accordance with some embodiments.

FIG. 23 is a plot showing backside coupling where a photonic chip was placed upon a microscope slide coverslip in accordance with some embodiments.

FIG. 24 shows the layout of another exemplary experimental multiplex photonic chip in accordance with some embodiments.

### DETAILED DESCRIPTION OF THE INVENTION

It is to be understood that the figures and descriptions of the present invention have been simplified to illustrate elements that are relevant for a clearer comprehension of the present invention, while eliminating, for the purpose of clarity, many other elements found in systems and methods of photonic biosensing. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

As used herein, each of the following terms has the meaning associated with it in this section.

The articles “a” and “an” are used herein to refer to one or to more than one (i.e., to at least one) of the grammatical objects of the article. By way of example, “an element” means one element or more than one element.

“About” as used herein when referring to a measurable value such as an amount, a temporal duration, and the like, is meant to encompass variations of +20%, ±10%, 5%, 1%, and ±0.1% from the specified value, as such variations are appropriate.

Ranges: throughout this disclosure, various aspects of the invention can be presented in a range format. It should be understood that the description in range format is merely for convenience and brevity and should not be construed as an inflexible limitation on the scope of the invention. Where appropriate, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Referring now in detail to the drawings, in which like reference numerals indicate like parts or elements throughout the several views, in various embodiments, presented herein is a multiplex photonic biosensor and photonic integrated circuit (PIC).

Disclosed herein are apparatus, systems, and methods for a low-cost photonic biosensor that provides for high performance for immunoassay diagnostics. The example biosensor disclosed herein uses silicon based photonic integrated circuits (“PICs) in conjunction with a substrate that provides for non-contact optical coupling and passive flow mechanisms. In some embodiments, one or more PICs are placed on a substrate, which enables the detection of one or more analytes in a fluid sample. In some embodiments, multiple assays may be placed on a substrate for multiplex assays. In some embodiments, a single PIC can be configured to perform multiplex assays. Additionally or alternatively, the substrate may also provide for fluorescence and/or colorimetric detection in conjunction with the refractive light detection provided by the PIC to provide further analyte characterization capabilities.

The current state of the art for traditional heterogeneous immunoassay diagnostics is based on technologies such as immunofluorescence or chemiluminescence detection in either solid phase or magnetic particle formats. Though cost has been reduced over the years for reagents, the management of complex automated test procedures (including multiple process steps, precise sample and reagent additions, long/variable assay specific incubation times, tight incubation temperature tolerances, multiple/complex wash protocols, and the use of special signal generating reagents), has led to the development of extremely expensive laboratory instrumentation. Additionally, this complexity leads to higher service rates and expensive operating costs (for labor, consumable expense, waste, and/or power utilization).

In contrast to traditional heterogeneous immunoassay diagnostics, the example photonic biosensor disclosed herein provides solutions that removes many of the on-analyzer process steps. Many on-analyzer steps are instead designed into the biosensor itself, such as sample analysis. The example photonic biosensor disclosed herein also reduces labor and operation expense, which provides for instrumentation that is significantly reduced in size and complexity while providing relatively high throughput.

The ability to measure immunoassays utilizing label free photonics significantly reduces the amount of required reagent. Further, the disclosed photonic biosensors reduce complexity of reaction processes (reduced instrument hardware) and provide a reduction in turnaround/analysis time (5-10 minutes). Further, as disclosed herein, the example biosensors provide for multiplexing of strategic test panels. Further, if desired, other measurement modalities including labeling strategies may be employed to enhance sensitivity.

The example methods, apparatus, and systems provide a photonic biosensor that includes a microfluidic slide, cassette, membrane, fibrous substrate, or test card. The photonic biosensor also includes at least one photonic integrated circuit (“PIC”) having a detection element that is connected to a fluid pathway provided on a slide, cassette, membrane, fibrous substrate, or test card. The example slide, cassette, membrane, fibrous substrate, or test card also includes an area for receiving a sample, where the fluid pathway uses wicking or capillary action (or other passive microfluidic transport structure) to passively pull a sample into contact with the detection element. Additionally, the slide, cassette, membrane, fibrous substrate, or test card includes optical ports for optically coupling with a light source and light detector of a laboratory analyzer, PoC device, or other analyte analysis device.

During use, in an example embodiment, a sample is applied to a receiving area surface of the example slide, cassette, membrane, fibrous substrate, or test card. A fluid pathway can include a passive microfluidic transport that causes the applied sample to flow to a detection zone and wicking zone. The detection zone includes a silicon-based PIC having a functionalized detection element. In some embodiments, the detection element of the PIC is functionalized with one or more types of capture molecules. In some embodiments, light is applied by a light source of an instrument to an input light port of the example slide, cassette, membrane, fibrous substrate, or test card, which directs the light through the PIC and the detection element. In some embodiments, light is applied through the example slide, cassette, membrane, fibrous substrate, or test card, which directs the light through the PIC and the detection element. In some embodiments, an output light port of the example slide, cassette, membrane, fibrous substrate, or test card receives the light after passing through the detection element. In some embodiments, output light is read directly through the example slide, cassette, membrane, fibrous substrate, or test card. Contact between the functionalized detection element and the fluid sample causes refractive light index changes, which are detected by a light detector or photosensor of the instrument. The degree of the refractive light index change is indicative of the presence of one or more analytes and/or a concentration of one or more analytes.

The use of passive fluid sample components and a contactless light interface significantly reduces the cost of the biosensor example slide, cassette, membrane, fibrous substrate, or test card compared to known biosensors with active fluid sample control and light interfaces. Further, the use of a silicon-based PIC provides high precision immunoassay diagnostics while using the available production scale of traditional silicon foundry manufacturing. Further, the disclosed biosensor slide or cassette with integrated PIC(s) enables the multiplexing of assays (e.g., panel testing) to further reduce cost, size, and waste.

In light of the disclosure herein and without limiting the disclosure in any way, in one aspect of the present disclosure, which may be combined with any other aspect listed herein unless specified otherwise, a photonic biosensor apparatus includes a substrate having a sample addition zone, a wicking zone, and a detection zone located between the sample addition zone and the wicking zone. The substrate also includes a fluid pathway that fluidly couples (e.g., in fluid communication with) the sample addition zone, the detection zone, and the wicking zone, an optical input port located at a section of the sample detection zone and configured to optically couple to a light source, and an optical output port located at the section of the sample detection zone and configured to optically couple to a light detector. The photonic biosensor apparatus also includes a photonic integrated circuit connected to the substrate at the section of the sample detection zone. The photonic integrated circuit includes a first grating coupler aligned with the optical input port, at least two second grating couplers aligned with the optical output port, at least one waveguide between the first grating coupler and the second grating coupler, and at least one detection element provided along the at least one waveguide and positioned to contact fluid sample within the fluid pathway at the section of the sample detection zone.

In another aspect of the present disclosure, which may be used in combination with any other aspect listed herein unless stated otherwise, the at least one detection element includes at least one of a ring resonator, a double ring resonator, a cylindrical resonator, a spherical resonator, a spiral waveguide, a photonic crystal, or a Mach-Zehnder Interferometer (“MZI”).

In another aspect of the present disclosure, which may be used in combination with any other aspect listed herein unless stated otherwise, the at least one waveguide includes a silicon nitride waveguide.

In another aspect of the present disclosure, which may be used in combination with any other aspect listed herein unless stated otherwise, the photonic integrated circuit has a rectangular prism or cuboid shape.

In another aspect of the present disclosure, which may be used in combination with any other aspect listed herein unless stated otherwise, the first grating coupler is provided at a first side of a face of the photonic integrated circuit, the at least two second grating couplers are provided at a second, opposing side of the same face of the photonic integrated circuit, and the at least one detection element is positioned between the first side and the second side.

In another aspect of the present disclosure, which may be used in combination with any other aspect listed herein unless stated otherwise, the photonic integrated circuit has a length between 2-20 mm, a width between 0.25-10 mm, and a height between 0.1-5 mm.

In another aspect of the present disclosure, which may be used in combination with any other aspect listed herein unless stated otherwise, the substrate includes an enhancer zone or a conjugate zone between the detection zone and the sample addition zone along the fluid pathway, the enhancer zone or the conjugate zone includes at least one reagent for binding with the fluid sample.

In another aspect of the present disclosure, which may be used in combination with any other aspect listed herein unless stated otherwise, the optical input port includes a first tunnel through the substrate and the optical output port includes a second tunnel through the substrate.

In another aspect of the present disclosure, which may be used in combination with any other aspect listed herein unless stated otherwise, the first tunnel is located on a first side of the fluid pathway in the section and the second tunnel is located on an opposite, second side of the fluid pathway in the section.

In another aspect of the present disclosure, which may be used in combination with any other aspect listed herein unless stated otherwise, the substrate includes at least one of a slide, cassette, membrane, fibrous substrate, or test card.

In another aspect of the present disclosure, which may be used in combination with any other aspect listed herein unless stated otherwise, the light source and the photodetector are included within a read head of at least one of a laboratory analyzer or a point-of-care (“PoC”) analyzer.

In another aspect of the present disclosure, which may be used in combination with any other aspect listed herein unless stated otherwise, at least some of the fluid pathway includes micropillars or projections that are substantially vertical to the surface of the substrate and having a height, diameter, and reciprocal spacing such that lateral capillary flow of the fluid sample is achieved.

In another aspect of the present disclosure, which may be used in combination with any other aspect listed herein unless stated otherwise, the height is between 1-1000 μm, the diameter is between 10-100 μm, and the reciprocal spacing is between 5-100 μm.

In another aspect of the present disclosure, which may be used in combination with any other aspect listed herein unless stated otherwise, the detection zone is configured to provide at least one of fluorescence or colorimetric detection of one or more analytes within the fluid sample.

In another aspect of the present disclosure, which may be used in combination with any other aspect listed herein unless stated otherwise, the photonic integrated circuit is connected to the substrate using at least one of a UV curable adhesive, physical stacking, or a tape/glue application.

In another aspect of the present disclosure, which may be used in combination with any other aspect listed herein unless stated otherwise, the optical input port is a first optical input port, the optical output port is a first optical output port, the section is a first section, and the photonic integrated circuit is a first photonic integrated circuit, and wherein the substrate further includes a second optical input port located at a second section of the sample detection zone and configured to optically couple to the light source, and a second optical output port located at the second section of the sample detection zone and configured to optically couple to the light detector.

In another aspect of the present disclosure, which may be used in combination with any other aspect listed herein unless stated otherwise, the apparatus further comprises a second photonic integrated circuit connected to the substrate at the second section, the second photonic integrated circuit including a first grating coupler aligned with the second optical input port, at least two second grating couplers aligned with the second optical output port, at least one waveguide between the first grating coupler and the second grating coupler, and at least one detection element provided along the at least one waveguide and positioned to contact fluid sample within the fluid pathway at the second section.

In another aspect of the present disclosure, which may be used in combination with any other aspect listed herein unless stated otherwise, the at least one detection element of the first photonic integrated circuit is configured for the detection of a first analyte and the at least one detection element of the second photonic integrated circuit is configured for the detection of a second analyte.

In light of the present disclosure and the above aspects, it is therefore an advantage of the present disclosure to provide a photonic biosensor with passive flow components and noncontact light coupling.

It is another advantage of the present disclosure to provide a relatively inexpensive photonic biosensor for PoC applications and mainframe laboratory applications.

It is another advantage of the present disclosure to provide a photonic biosensor that provides for multiplex assays on a single slide, cassette, membrane, fibrous substrate, or test card.

It is another advantage of the present disclosure to provide a photonic sensor with fluorescence or colorimetric detection on a single slide, cassette, membrane, fibrous substrate, or test card.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

Photonic-based diagnostic technologies promise to deliver platforms that are quantitative, multiplex, and inexpensive, by leveraging the highly scalable processes developed for the fabrication of semiconductor microchips. However, in practice, the affordability of these platforms is limited by complex and expensive sample handling. A deficiency of related previous technologies is the inability to detect more than two or three analytes (i.e. proteins in a blood sample) at a time. The multiplex system disclosed herein corrects these deficiencies.

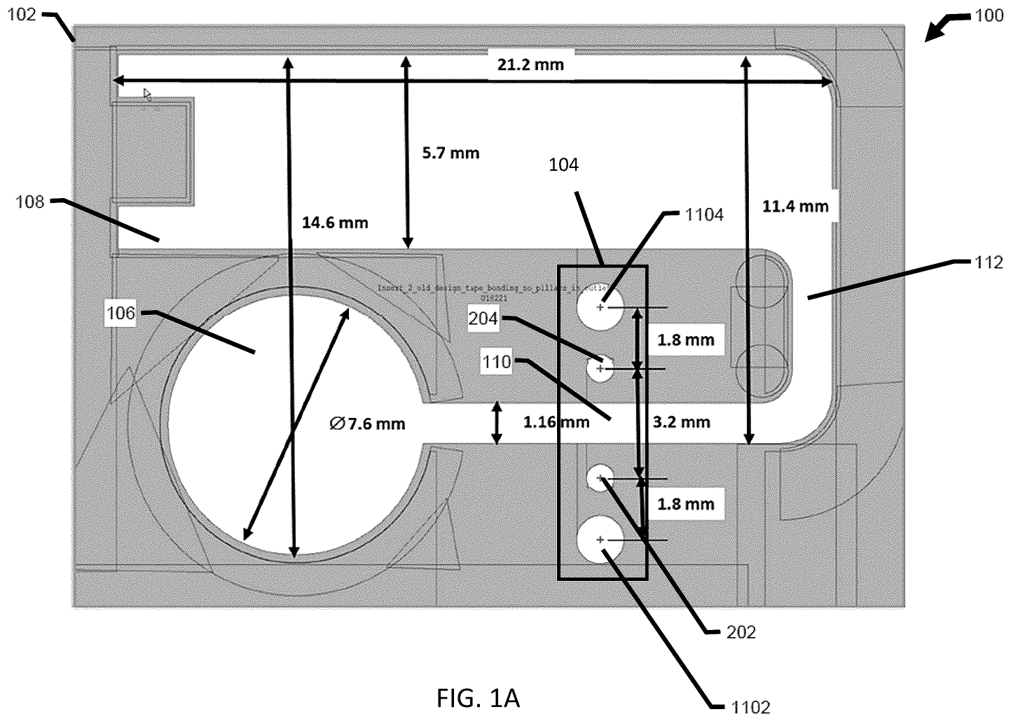

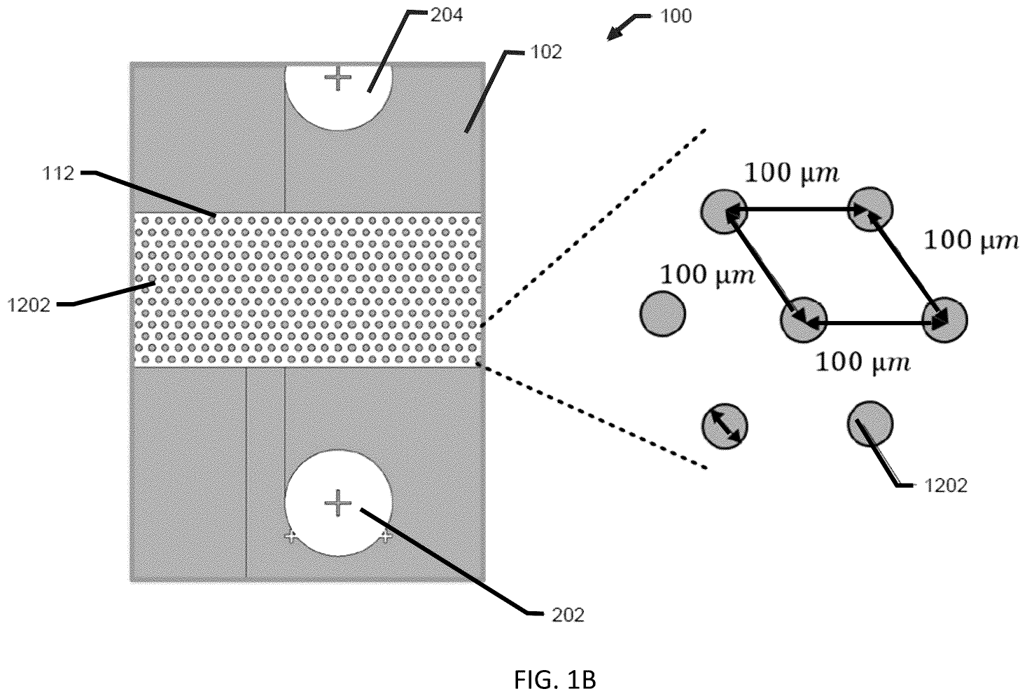

FIG. 1A is a diagram of a photonic biosensor 100, according to an example embodiment of the present disclosure. The example biosensor 100 includes a substrate 102, which may include a slide, cassette, membrane, fibrous substrate, or test card. The substrate 102 may be constructed from glass, plastic, composites, cyclic olefin copolymers, polystyrene, polymethymethacrylate (“PMMA”), nylon, polycarbonate, or combinations thereof. Further, the substrate 102 may be manufactured via hot embossing, micro molding, or any other molding or printing method.

The example substrate includes a sample addition zone 106, a wicking zone 108, and a detection zone 110. The zones 106 to 110 are fluidly coupled together (e.g., in fluid communication) via a fluid pathway 112. The sample addition zone 106 includes a metering port for receiving a fluid sample. The example wicking zone 108 provides an area for flow control and/or waste collection. The wicking zone 108 provides a termination point of the fluid pathway, while the sample addition zone 106 provides a starting point. In some embodiments, the wicking zone 108 may be covered by tape support, which provides physical protection of accumulated fluid sample in the wicking zone 108. An entry section leading to the wicking zone 108 may be configured to pull the fluid sample into the wicking zone 108 to prevent the fluid sample from backing up through the detection zone 110.

The example substrate 102 may, in some embodiments, include an optical enhancer zone (e.g., a conjugate zone). The optical enhancer zone is located downstream from the sample addition zone 106. In some embodiments, the optical enhancer zone is located adjacent to the sample addition zone 106. Further, the optical enhancer zone is located upstream from the detection zone 110 and the wicking zone 108. The optical enhancer zone includes one or more reagents for binding with a fluid sample. In some embodiments, the fluid sample dissolves fluorescent labeled conjugates as the fluid sample flows through the optical enhancer zone.

The example detection zone 110 includes one or more test zones that are configured to capture a bound specific antigen/conjugate complex. The different test zones may provide for the detection of a sample analyte or different analytes. A concentration or presence of bound antigen/conjugate complex at each test zone is measured using fluorescence or colorimetric detection. In some instances, after conjugate in the optical enhancer zone is completely dissolved, the fluid sample acts as a wash and removes unbound material into the wicking zone 108. After a complete wash by the fluid sample, the test zones of the detection zone 110 may be read with a fluorimeter or other optical analyzer. It should be appreciated that in some embodiments, the detection zone 110 may not be needed. In these embodiments, the detection zone 110 is replaced by the fluid flow path 112.

In some embodiments, at least some of the fluid pathway 112, the sample addition zone 106, the optical enhancer zone, the detection zone 110, and/or the wicking zone 108 may include a plurality of projections or micropillars. The example projections or micropillars are substantially vertical to a surface of the substrate 102 and have a height, diameter, and reciprocal spacing such that lateral capillary flow of the fluid sample is achieved. In some embodiments, the projections or micropillars have a height that is between 1-1000 μm, a diameter that is between 10-100 μm, and reciprocal spacing that is between 5-100 μm, preferably between 10-25 μm. In some instances, a base of the projections or micropillars may have a greater diameter compared to a top. In these instances, a diameter of the projections or micropillars may taper from the base to the top.

Example substrates are described further in U.S. Pat. Nos. 10,073,091, 9,689,870, 9,389,228, 9,285,361, 8,895,293, 8,821,812, 8,409,523, and 8,025,854, where each are hereby incorporated by reference in their entirety.

In some embodiments, the PIC 104 may be used in conjunction with one or more detector sections of the detection zone 110. The detector sections may be configured for colorimetric/digital detection and/or fluorescence detection. The sample addition zone 106 is configured to receive serum/plasma, whole blood, or other fluids for analysis by the PIC 104 and the detector sections. The optical enhancer zone may provide one or more capture options, including conjugate capture and/or mass enhancer capture. Further, the wicking zone 108 may include one or more features such as fluid control and/or end of test detection. In some embodiments, the wicking zone 108 may include a porous material to enhance fluid flow.

As described above in connection with FIG. 1A, the fluid pathway 112 may provide for fluid flow using micropillars. The micropillars may be placed in the sample addition zone 106, the wicking zone 108, the detection zone 110, optical enhancer zone, the wash zone, and/or space between these zones along the fluid pathway 112. In other embodiments, capillary flow may be achieved without the use of micropillars. For example, the fluid pathway 112 and/or the zones 106, 108, and/or 110 may be achieved using texturing/surface patterning. Alternatively, capillary flow may be achieved using porous media (e.g., “paper in poly”, fiber materials, or thread/fabric bundles). In other embodiments, capillary flow may be provided using a thin film coating and/or various coated spreading layers and channel beads. Coatings to provide a wettable/hydrophilic surface for the fluid pathway 112 and/or the zones 106, 108, and/or 110 include oxygen plasma treatment, neutral atom beam bombardment, gas cluster ion beam bombardment, surface silanization, etc.

FIG. 1B is a diagram of an example micropillar layout for a fluid flow path 112 of the substrate 102 for the biosensor 100 of FIG. 1A, according to an example embodiment of the present disclosure. Micropillars 1202 are placed within the fluid flow path 112, including at locations along the fluid flow path 112 that align with a functionalized detection element 212 of the PIC 104. The micropillars 1202 may include cylinders having 50 μm diameters. As shown, the micropillars 1202 are placed in a hexagonal array such that the micropillars 1202 are spaced apart by 100 μm. The spacing and size of the micropillars 1202 provides for capillary flow along the fluid flow path 112.

In other embodiments, the micropillars have a rectangular shape. In these other embodiments, the micropillars may be placed into rows, with 50 μm to 150 μm of space between adjacent micropillars. Further each adjacent row may be offset from each other. The offset may correspond to gaps of adjacent rows such that a micropillar in one row is aligned with a gap between micropillars in an adjacent row.

In some embodiments alignment channels 1102 and 1104 are formed in the substrate 102. The alignment channels 1102 and 1104 may include through holes or apertures, and are located adjacent to respective ports 202 and 204.

In an example, the photonic reader includes alignment pins. After the biosensor 100 is moved into a specified location within the laboratory instrumentation, the photonic reader and/or the substrate 102 is moved such that the alignment pins pass through the alignment channels 1102 and 1104. This provides fast alignment. In some embodiments after the rough alignment, the photonic reader and/or the substrate 102 may have alignment fine-tuned to ensure a light source and a light detector are optically aligned with the optical input port 202 and the optical output port 204.

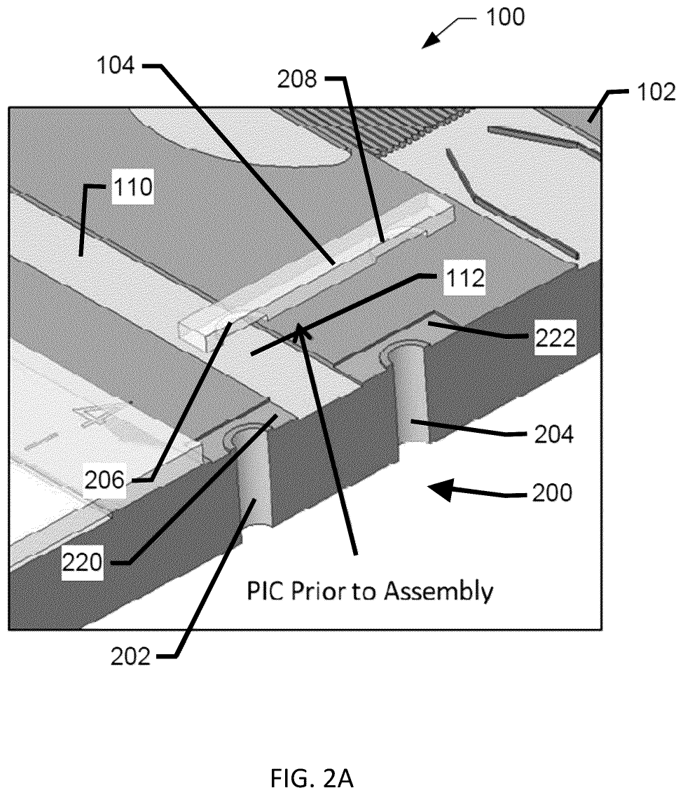

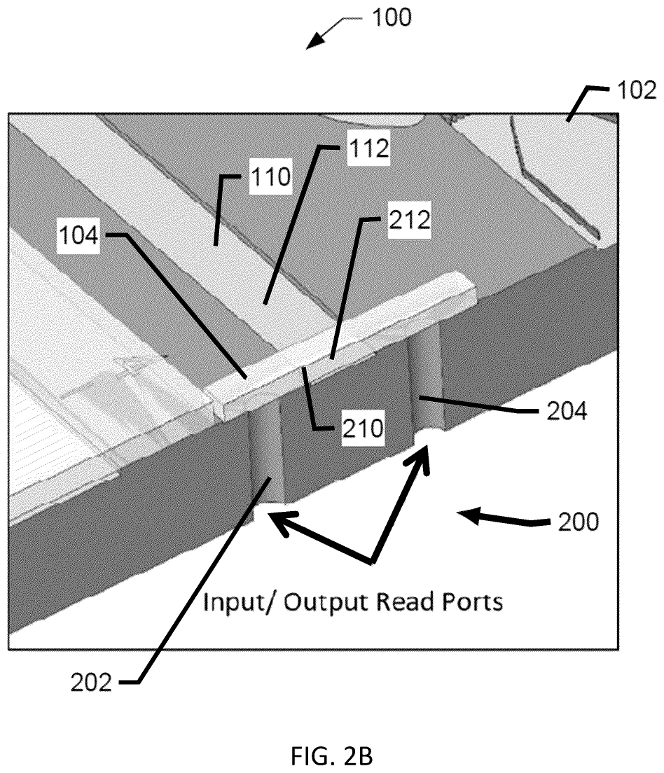

It should be noted that while FIGS. 1A, 1B, 2A, and 2B show one input port 202 and one output port 204, in other embodiments, the substrate 102 may have more than one input port, no input ports, more than one output port, and/or no output ports. In some embodiments, a larger output port enables the use of multiple channels in the PIC 104 for multiplexing. In some embodiments, the use of multiple ports enables the use of multiple channels in the PIC 104 for multiplexing. For example, the substrate may have a single input port 202 and multiple output ports 204. In this example, the PIC 104 has multiple channels corresponding to the number of output ports 204. Light received via the input port 202 is split along the separate channels to provide different types of optical analysis. Additionally or alternatively, the substrate 102 may include multiple input ports 202 and multiple output ports 204 (and/or multiple pairs of alignment channels) to accommodate multiple PICs 104 placed at different locations along the flow path 112.

FIG. 1A also shows approximate dimensions of an exemplary biosensor 100, which has a length of about 22 mm and a width of about 15 mm. In this example, the sample addition zone 106 has a width of 5.7 mm and a length of 21.2 mm. The flow path has a width of 1.16 mm, and the wicking zone 108 has a diameter of 7.6 mm. It should be appreciated that the biosensor 100 may have alternative dimensions based on design and end-use application.

In some embodiments, the alignment channels 1102 and 1104 and the ports 202 and 204 may be omitted. In these alternative embodiments, light coupling is provided directly to the waveguide 210 of the PIC 104. In an example, an input fiber connected to a light source is configured to align with a side of the PIC 104 to optically couple directly with the waveguide 210. An output fiber is placed on an opposing side of the PIC 104 to receive the light.

The example substrate 102 of FIG. 1A also includes optical ports for noncontact optical coupling with a read head of a laboratory analyzer or PoC analyzer. FIGS. 2A and 2B show a cut-away of the substrate 102 at a section 200 of the sample detection zone 110 that includes an optical input port 202 and an optical output port 204, according to an example embodiment of the present disclosure. The input port 202 is configured to optically couple to a light source and the output port 204 is configured to optically couple to a light detector. To provide non-contact optical alignment, the substrate 102 is positioned in an analyzer instrument such that a light source is directly aligned with the optical input port 202. Similarly, the positioning of the substrate 102 in the analyzer instrument causes the output port 204 to align with an optical detector. This non-contact coupling eliminates the need for complex optical coupling with the PIC 104.

The optical input port 202 includes a first tunnel through the substrate 102 and the optical output port 202 includes a separate, second tunnel through the substrate 102. While the tunnels are shown as being cylindrical, the tunnels may have other profiles, such as rectangular triangular, etc. In the illustrated embodiment, the input port 202 is shown as being on one side of the fluid pathway 112, while the output port 204 is shown as being on an opposite side of the fluid pathway 112. In other embodiments, the ports 202 and 204 maybe on a same side of the fluid pathway 112.

FIGS. 2A and 2B also show an enlarged view of the PIC 104. FIG. 2A shows a diagram of the PIC 104 prior to connection to the substrate 102. FIG. 2B shows a diagram of the PIC 104 after placement on the substrate 102. The example PIC 104 includes a first grating coupler 206 that is aligned with the optical input port 202. The PIC 104 also includes a second grating coupler 208 that is aligned with the optical output port 204. The grating couplers 206 and 208 have shapes that conform to the circular profiles of the respective optical ports 202 and 204.

The grating couplers 206 and 208 include periodic etch structures that diffract light in a certain direction. In the illustrated example, the grating coupler 206 diffracts light from a vertical direction through the optical input port 202 to a horizontal direction through the PIC 104. Additionally, the grating coupler 208 diffracts light from a horizontal direction from the PIC 104 to a vertical direction through the optical output port 204. In other embodiments, the grating couplers may be replaced with mirrors or a reflective coating that directs light between the ports 202 and 204 and the PIC 104.

The example PIC 104 also includes at least one waveguide 210 between the first grating coupler 206 and the second grating coupler 208. Further, the PIC 104 includes at least one detection element 212 that are provided along the at least one waveguide 210. The detection element 212 is positioned to contact a fluid sample within the fluid pathway 112. It should be appreciated that the detection element 212 and/or the PIC 104 generally does not block fluid passage along the fluid pathway 112. Instead, a small space is provided between a floor of the fluid pathway 112 and the detection element 212 to enable a fluid sample to pass through. In some embodiments, the small space is between 10 μm and 5000 μm.

Also, as shown in FIG. 2A, the substrate 102 may include recess sections 220 and 222 around the ports 202 and 204 for receiving corresponding sides of the PIC 104. The recessed sections 220 and 222 enable the PIC 104 to be securely connected to the substrate 102. In some embodiments, at least one of a UV curable adhesive, physical stacking, or a tape/glue application is used to secure the PIC 104 to the substrate 102 at the recess sections 220 and 222.

In one embodiment, the PIC 104 is configured for front-side coupling wherein the PIC 104 is coupled to a top surface of the substrate 102 opposite the fiber bundle 120.

In one embodiment, the PIC 104 is configured for back-side coupling wherein the PIC 104 is coupled to a bottom surface of the substrate 102 between the substrate 102 and the fiber bundle 120.

In some embodiments, the photonic biosensor apparatus 100 includes a sample addition zone 106 in fluid communication with a wicking zone 108 and a sample detection zone 110, wherein the sample detection zone 110 is between the sample addition zone 106 and the wicking zone 108. In some embodiments, the biosensor apparatus 100 further includes at least one optical input port 202 disposed within the sample detection zone 110, wherein the optical input port 202 is configured to optically couple to a light source. In some embodiments, the biosensor apparatus 100 further includes at least one optical output port 204 disposed within the sample detection zone 110, wherein the optical output port 202 is configured to optically couple to a photodetector via a fiber bundle 120. In some embodiments, the biosensor apparatus 100 further includes at least one photonic integrated circuit (PIC) 104 disposed directly atop a substrate 102. Further details of the PIC 104 are described below.

In some embodiments, the fiber bundle 104 comprises a plurality of individual fibers. In some embodiments, the individual fibers of the fiber bundle 104 comprise multimode fibers and/or singlemode fibers. In some embodiments, the individual fibers of the fiber bundle 104 comprise one singlemode fiber and a at least one multimode fibers. In some embodiments, the individual fibers of the fiber bundle 104 are positioned in a hexagonal close-packing configuration. In some embodiments, the individual fibers of the fiber bundle 104 are positioned in a square close-packing configuration.

In some embodiments, the apparatus 100 is configured to detect three or more measurands simultaneously. In some embodiments, the apparatus 100 the apparatus is configured to detect three or more analytes simultaneously.

In some embodiments, the substrate 102 comprises at least one of a slide, cassette, membrane, fibrous substrate, or test card. In some embodiments, the light source and the photodetector are included within a read head of at least one of a laboratory analyzer or a point-of-care (“PoC”) analyzer.

In some embodiments, the apparatus 100 further comprises at least one of a fluid pathway, a paper pathway, or a membrane pathway that fluidly couples the sample addition zone 106, the detection zone 110, and the wicking zone 108. In some embodiments, the fluid pathway includes micropillars or projections that are substantially vertical to the surface of the substrate and having a height between about 1 μm to 1000 μm, a diameter between about 10 μm to 100 μm, and a reciprocal spacing between the micropillars between about 5 μm to 100 μm such that lateral capillary flow of the fluid sample is achieved.

In some embodiments, the detection zone 110 is configured to provide at least one of fluorescence, refractive index shift, Raman signal, absorbance signal, plasmonic shift or colorimetric detection of one or more analytes within the fluid sample. In some embodiments, the PIC 104 is connected to the substrate 102 using at least one of a UV curable adhesive, physical stacking, lamination or a tape/glue application.

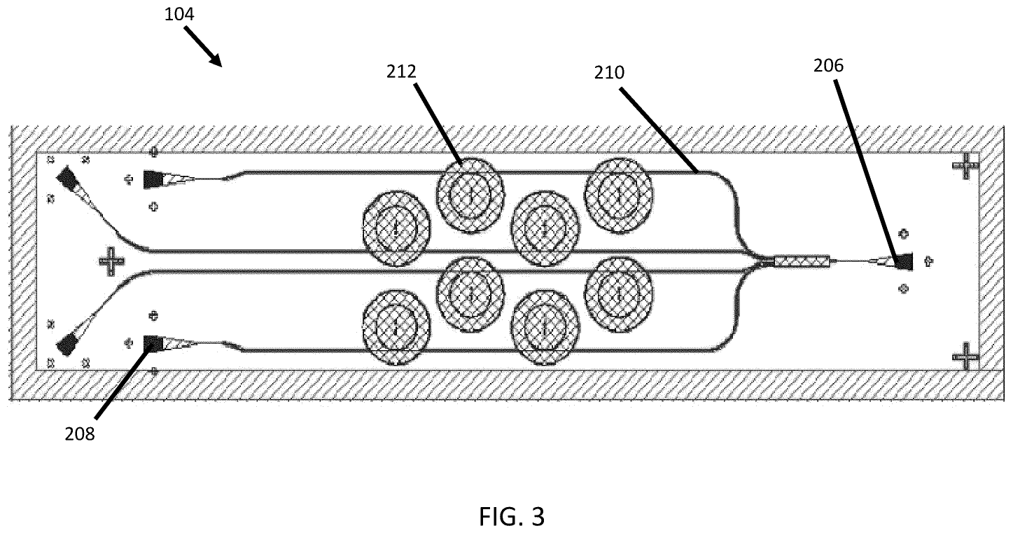

FIG. 3 shows an exemplary PIC 104. In the example shown, the PIC 104 includes at least one first (input) grating coupler 206, at least two second (output) grating couplers 208, at least one waveguide 210 between the first grating coupler 206 and the second grating couplers 208, and at least one detection element 212 disposed within the at least one waveguide 210. In some embodiments, the at least one first (input) grating coupler 206 is aligned with an optical input port 202. In some embodiments, the at least two second (output) grating couplers 208 aligned with an optical output port 204.

In some embodiments, the at least one detection element 212 can include at least one capture molecule. In some embodiments, the capture molecule is configured to capture analytes, such as proteins, antibodies, peptides, nucleic acids, and any other suitable substance. In some embodiments the at least one detection element 212 includes at least one of a ring resonator, a double ring resonator, a cylindrical resonator, a spherical resonator, a spiral waveguide, photonic crystal, a Mach-Zehnder Interferometer (“MZI”), and any other suitable design or combinations thereof.

In some embodiments, the at least one waveguide 210 comprises a silicon nitride waveguide. In some embodiments, the at least one waveguide 210 splits into a plurality of branches from the first grating coupler 206 to the at least two second grating couplers 208. In some embodiments, the at least one detection element 212 is positioned on one of the plurality of branches. In some embodiments, the at least one detection element 212 is positioned to contact a fluid sample within the sample detection zone 110.

In some embodiments, the PIC 104 comprises a rectangular prism or cuboid shape. In some embodiments, the PIC 104 has a length between 2-20 mm (e.g., 4 mm), a width between 0.25-10 mm (e.g., 1 mm), and a height between 0.1-5 mm. In some embodiments, an array of PICs 104 may be connected to the substrate 102 for multiplex applications. In some embodiments, the PIC 104 can include 0 to 100, 1 to 20, 2 to 10, 2 or more, 5 or more, 8 or more, or any suitable number of detection elements 212. In some embodiments, a PIC 104 with zero detection elements 212 may be included in an array. In some embodiments, the PIC 104 may be used as a reference for light calibration and/or adjustment.

In some embodiments, the at least one detection element 212 has an extinction ratio greater than 5 dB under aqueous cladding. In some embodiments, each detection element 212 has a unique extinction ratio. In some embodiment, the spectral footprint of individual detection elements 212 sharing the same bus waveguide may be made distinguishable by altering the quality factor and/or extinction ratio, thus enabling the identification of control/experimental rings. In some embodiments, intentional reduction of the quality factor and/or extinction ratio broadens (or lessens the depth of) resonance dips in the spectrum, effectively labeling the ring in question based on the peak shape.

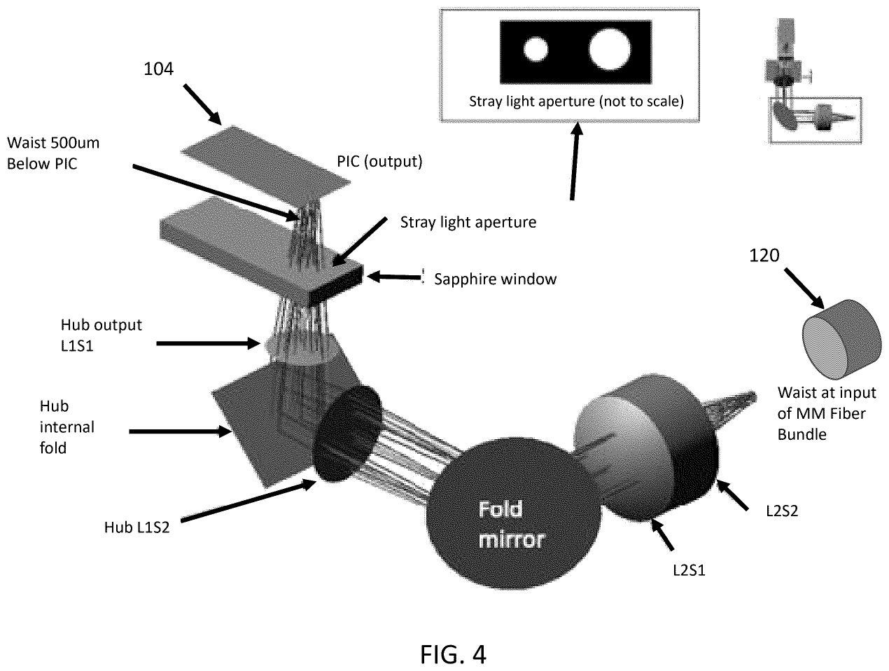

FIG. 4 shows a ray diagram of an exemplary multiplex hub optical system of the biosensor 100. Light emitted from the output gratings 208 of the PIC 104 passes through the first surface of the hub output lens L1S1, reflects 90-degrees off the angled interior surface of the hub and exits the second surface L1S2 into free space as a collimated beam. The beam then reflects 90 degrees toward lens L2, which focuses the beam on to facet of the fiber bundle 120. Contrary to the usual implementation of fiber bundles, in this case, each fiber is intended to capture light from a single light source within an array of discrete sources. The fibers of the fiber bundle 120 can be any suitable arrangement including hexagonal close packing and/or square close packing.

In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C#, Objective-C, Java, JavaScript, MATLAB, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of the invention may be implemented over a Virtual Private Network (VPN).

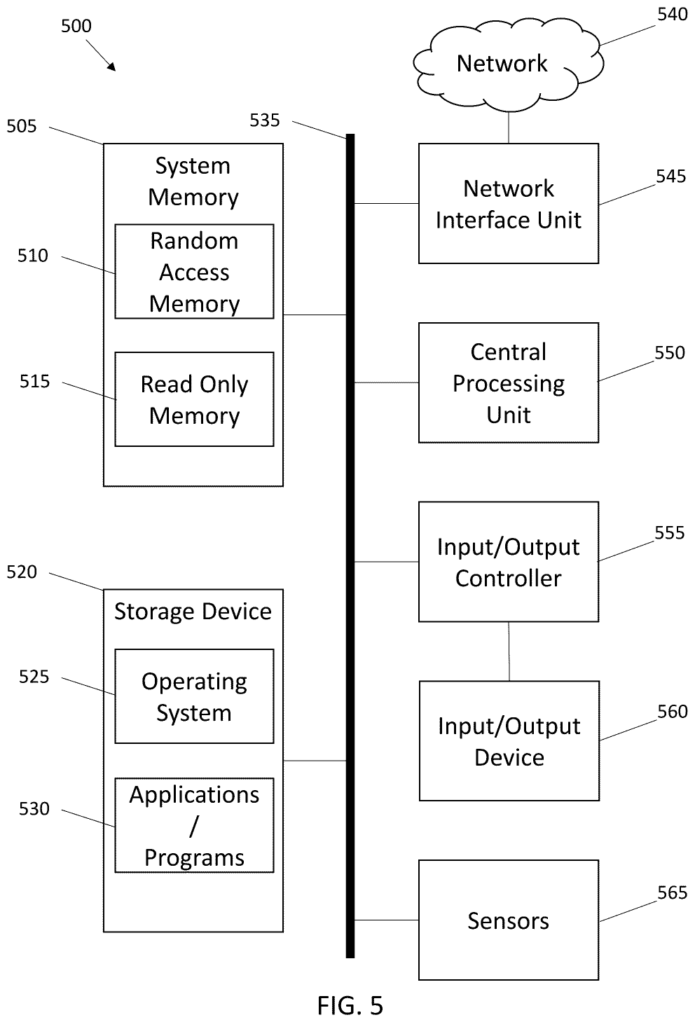

FIG. 5 and the following discussion are intended to provide a brief, general description of a suitable computing environment in which the invention may be implemented. While the invention is described above in the general context of program modules that execute in conjunction with an application program that runs on an operating system on a computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

FIG. 5 depicts an illustrative computer architecture for a computer 500 for practicing the various embodiments of the invention. The computer architecture shown in FIG. 5 illustrates a conventional personal computer, including a central processing unit 550 (“CPU”), a system memory 505, including a random-access memory 510 (“RAM”) and a read-only memory (“ROM”) 515, and a system bus 535 that couples the system memory 505 to the CPU 550. A basic input/output system containing the basic routines that help to transfer information between elements within the computer, such as during startup, is stored in the ROM 515. The computer 500 further includes a storage device 520 for storing an operating system 525, application/program 530, and data.

The storage device 520 is connected to the CPU 550 through a storage controller (not shown) connected to the bus 535. The storage device 520 and its associated computer-readable media, provide non-volatile storage for the computer 500. Although the description of computer-readable media contained herein refers to a storage device, such as a hard disk or CD-ROM drive, it should be appreciated by those skilled in the art that computer-readable media can be any available media that can be accessed by the computer 500.

By way of example, and not to be limiting, computer-readable media may comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the computer 500 may operate in a networked environment using logical connections to remote computers through a network 540, such as TCP/IP network such as the Internet or an intranet. The computer 500 may connect to the network 540 through a network interface unit 545 connected to the bus 535. It should be appreciated that the network interface unit 545 may also be utilized to connect to other types of networks and remote computer systems.

The computer 500 may also include an input/output controller 555 for receiving and processing input from a number of input/output devices 560, including a keyboard, a mouse, a touchscreen, a camera, a microphone, a controller, a joystick, or other type of input device. Similarly, the input/output controller 555 may provide output to a display screen, a printer, a speaker, or other type of output device. The computer 500 can connect to the input/output device 560 via a wired connection including, but not limited to, fiber optic, ethernet, or copper wire or wireless means including, but not limited to, Bluetooth, Near-Field Communication (NFC), infrared, or other suitable wired or wireless connections.

As mentioned briefly above, a number of program modules and data files may be stored in the storage device 520 and RAM 510 of the computer 500, including an operating system 525 suitable for controlling the operation of a networked computer. The storage device 520 and RAM 510 may also store one or more applications/programs 530. In particular, the storage device 520 and RAM 510 may store an application/program 530 for providing a variety of functionalities to a user. For instance, the application/program 530 may comprise many types of programs such as a word processing application, a spreadsheet application, a desktop publishing application, a database application, a gaming application, internet browsing application, electronic mail application, messaging application, and the like. According to an embodiment of the present invention, the application/program 530 comprises a multiple functionality software application for providing word processing functionality, slide presentation functionality, spreadsheet functionality, database functionality and the like.

The computer 500 in some embodiments can include a variety of sensors 565 for monitoring the environment surrounding and the environment internal to the computer 500. These sensors 565 can include a Global Positioning System (GPS) sensor, a photosensitive sensor, a gyroscope, a magnetometer, thermometer, a proximity sensor, an accelerometer, a microphone, biometric sensor, barometer, humidity sensor, radiation sensor, or any other suitable sensor.

The aforementioned systems, processes and methods described herein may be utilized for desired applications as would be appreciated by those skilled in the art. For example, the aforementioned systems, processes and methods described herein can be utilized as a disposable multiplex assay in measuring the presence or level of analytes, such as proteins, antibodies, peptides, nucleic acids, antigens, viruses, metabolites, and any other suitable substance.

In one example, antibody response for clinical diagnostics of individuals to various diseases such as SARS-CoV-2 and influenza antigens. Furthermore, the aforementioned systems, processes and methods described herein can be utilized with any suitable system, such as those described in U.S. patent application Ser. No. 17/585,914, and hereby incorporated herein by reference in its entirety.

### EXPERIMENTAL EXAMPLES

The invention is now described with reference to the following Examples. These Examples are provided for the purpose of illustration only and the invention should in no way be construed as being limited to these Examples, but rather should be construed to encompass any and all variations which become evident as a result of the teaching provided herein.

Without further description, it is believed that one of ordinary skill in the art can, using the preceding description and the following illustrative examples, make and utilize the present invention and practice the claimed methods. The following working examples therefore, specifically point out exemplary embodiments of the present invention, and are not to be construed as limiting in any way the remainder of the disclosure.

As the third year of the COVID-19 pandemic approaches, there have been over 230 million reported cases and over 4.6 million deaths (Dong et al., 2020). Despite the availability of vaccines, new SARS-CoV-2 variants continue to emerge, initiating new waves of infection among the unvaccinated, and by breaking though vaccines. New diagnostics have been released that can rapidly measure serum antibodies against SARS-CoV-2. However, as new variants, and unusual surges of RSV and influenza emerge, an inexpensive multiplex diagnostic is needed to assess immunity in individuals. To address the need for multiplex detection, new approaches to both the sensor itself and the optical I/O system (the “hub”) were required.

The first-generation hub allowed for coupling to a single input, and a single output grating. This limited the multiplex-capability of the design because it is difficult to interpret spectra with more than two sensing rings per bus waveguide. Constrained by the 1×4 mm PIC geometry and the width of the micropillar channel, it was found that it was possible to fit eight rings with four bus waveguides onto a multiplex PIC. By using a four-way splitter, the input of the optical hub and PIC could remain unchanged. However, it required a different design for the output in order to capture output light from four distinct gratings. This was best accomplished by using a fiber bundle that would yield a reproducible configuration of close-packed output fibers. Then the output gratings could be positioned to match this configuration, and a new lens design would image the gratings on to the bundle with the appropriate magnification.

SARS-CoV-2, has been shown to depend on the coronavirus surface spike glycoprotein (S protein) interaction with receptor angiotensin-converting enzyme 2 (ACE2) for cellular entry (Hoffmann et al., 2020; Zhou et al., 2020). Recent structural studies have established that S protein interfaces with ACE2 via the receptor binding domain (RBD) (Wrapp et al., 2020; Yan et al., 2020). Furthermore, the presence of antibodies against N-protein has been shown to distinguish between individuals who acquired immunity through infection versus vaccination. Herein is shown the detection of antibodies against several SARS-CoV-2 antigens (RDB, S1+S2, N), as well as influenza A H3N2 (A/Switzerland/9715293) in human samples.

Recombinantly expressed (baculovirus) SARS-CoV-2 antigens (RBD, S1+S2, N) and Influenza A H3N2 (A/Switzerland/9715293) hemagglutinin from Sino Biological, Inc. (Wayne, PA) were used. Anti-fluorescein (anti-FITC) antibody used as a nonspecific binding control was obtained from Rockland Immunochemicals (Limerick, PA). The diluent for antibody/antigen printing was modified (i.e., potassium-free) phosphate-buffered saline (mPBS). Assay wash buffer (AWB), which was used to dilute serum samples, consisted of mPBS with 3 mM EDTA and 0.01% Tween-20. All serum samples were diluted 1-to-5 in AWB. Pooled normal human serum (PNHS) was purchased (Innovative Research, Novi, MI) and also diluted 1-to-5 in AWB for use as a block for nonspecific binding, as well as a refractive index-matching fluid to prep the device for assaying each serum sample. ACS reagent-grade toluene (Fisher) was distilled over sodium metal immediately prior to use.

Serum samples were obtained from convalescent COVID-19 patients. All subjects were at least 14 days out of active disease. Samples from vaccination subjects were obtained. All subjects were at least 18 years of age at the time of blood draw, and subject to informed consent.

Whole blood samples were allowed to clot for 30 minutes after draw. Samples were then spun at 1200×g for 5 min, and serum was pipetted off into a 15 mL conical tube and spun again for 10 minutes to remove any remaining cellular material. The serum was then aliquoted and stored at −80° C. until use.

Silicon nitride ring resonators were designed with an upper aqueous cladding for use in biosensing. The ring resonators studied in this work comprised silicon nitride waveguides 1.5 μm wide and 220 nm tall, supporting a single transverse electric (TE) polarization mode. Modeling was performed using the finite difference (FD) method in OptoDesigner, a component of the Synopsys Photonic Design Suite.

Detailed descriptions of the layer stack and modeling of microring resonators have been reported previously (Cognetti et al., 2021). In order to fit eight rings within the 800-micron width of the PIC, the ring diameter was decreased to 164 microns and the coupling gap was decreased to 375 nm to compensate for increased bending losses and maintain critical coupling. Sensor PICs were designed to have two rings per bus waveguide with slightly different diameters in order to provide resonance signals at two different wavelengths. Each PIC comprised eight exposed rings for sensing. In experiments detailed below, four rings were designated as the experimental, and four as reference.

The multiplex PIC was a 1×4 mm PIC design featuring a single input grating, a 4-way MMI splitter, eight microring resonators (2 per bus waveguide), and four output gratings. Fiducial marks on the PIC surface were provided for use by an automated alignment system.

The grating coupler design has been described in detail previously (Cognetti et al., 2021). On the output side of the PIC four gratings were positioned such that they would output light to the four uppermost and lowermost fibers of a custom 7 fiber bundle that is described in more detail below. This fiber bundle configuration can reasonably accommodate up to a 14-plex assay. The bundle is not limited to serving as output alone, one or more of the fibers in the bundle may also be used a concurrent input.

Photonic sensors were fabricated in a custom run format using the 300 mm AIM Photonics fabrication line (Fahrenkopf et al., 2019) with modifications to the standard AIM passive multi-project wafer (MPW) process and layer stack.

Following fabrication, wafers were diced by an external vendor (GDSI), and returned on dicing tape. Prior to functionalization, sensor PICs were removed from the dicing tape and first washed for 15 minutes in a 1-to-1 mixture of methanol and concentrated hydrochloric acid, then rinsed 4×30 seconds in Nanopure water and dried with nitrogen. PICs were next placed in a chemical vapor deposition (CVD) oven (Yield Engineering Systems, Fremont, CA). where a monolayer of (3-Glycidyloxypropyl)trimethoxysilane (GOPS; Gelest, Inc., Morrisville, PA) was deposited on the surface.

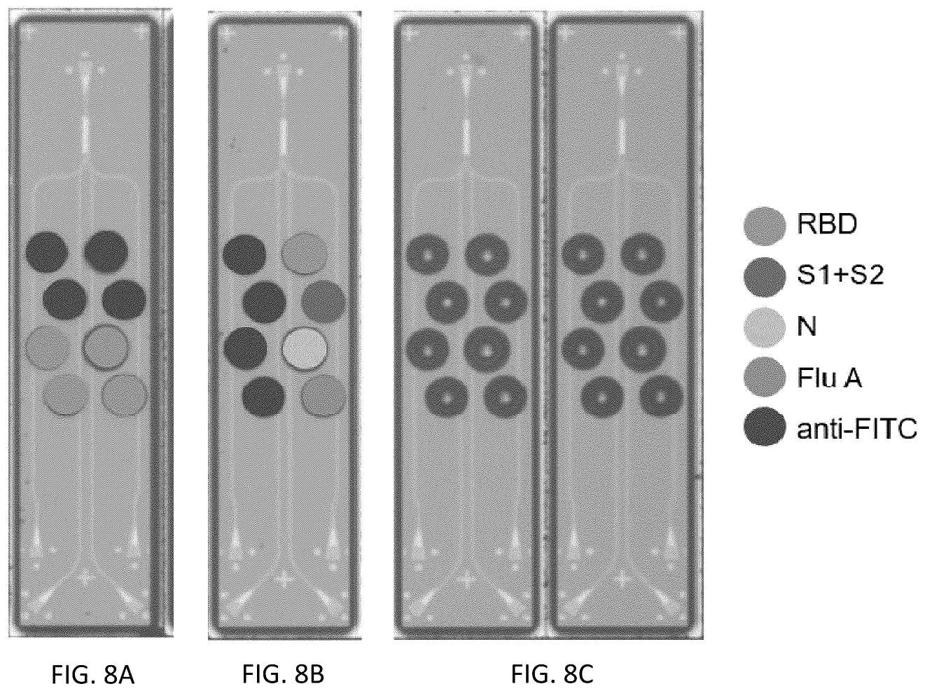

Antigens and control antibodies were covalently attached to the functionalized surface by spotting them directly on the rings using a sciFLEXARRAYER SX piezoelectric microarrayer (Scienion AG, Berlin, Germany), using the manufacturer's Find Target Reference Points (FTRP) machine vision protocol to accurately locate the position of the rings. The control rings were spotted with anti-FITC antibody at 550 μg/mL in mPBS (pH 5.8), and the test rings with SARS-CoV-2 receptor-binding domain (RBD) peptide, S1+S2 extracellular domain, N-protein, or Influenza A H3N2 (A/Switzerland/9715293) hemagglutinin at 400 μg/mL in mPBS (pH 7.2). The configuration for PICs functionalized with only RBD and anti-FITC is shown in FIG. 8A. The configuration for PICs functionalized with all probes is presented in FIG. 8B. All rings received approximately 3 nL of antibody/antigen solution. Chips were maintained at 75% humidity for 30 minutes, then overspotted with an equivalent volume of stabilizer solution (StabilGuard Immunoassay Stabilizer, Surmodics IVD Inc., Eden Prairie, MN). An image of the PICs after StabilGuard has been applied is shown in FIG. 8C. Twenty minutes after stabilizer was spotted onto the rings, PICs were removed from the arrayer and kept in a desiccator for at least 4 hours and until use.

FIG. 8A shows a functionalization for a ‘singleplex’ experiment with replicates. Four rings were printed with anti-FITC as a negative control and four rings were printed with RBD antigen. FIG. 8B shows a functionalization for a ‘multiplex’ experiment with four ant-FITC replicates and RBD, S1+S2, N, and Flu A antigens printed on one ring each. FIG. 8C shows an image of PICs after printing respective capture probe and overspotting with StabilGuard.

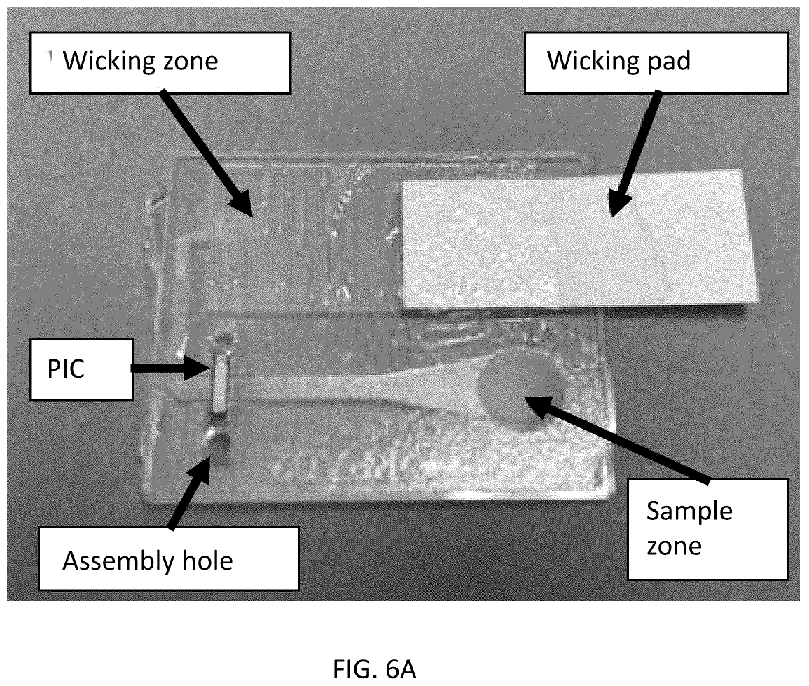

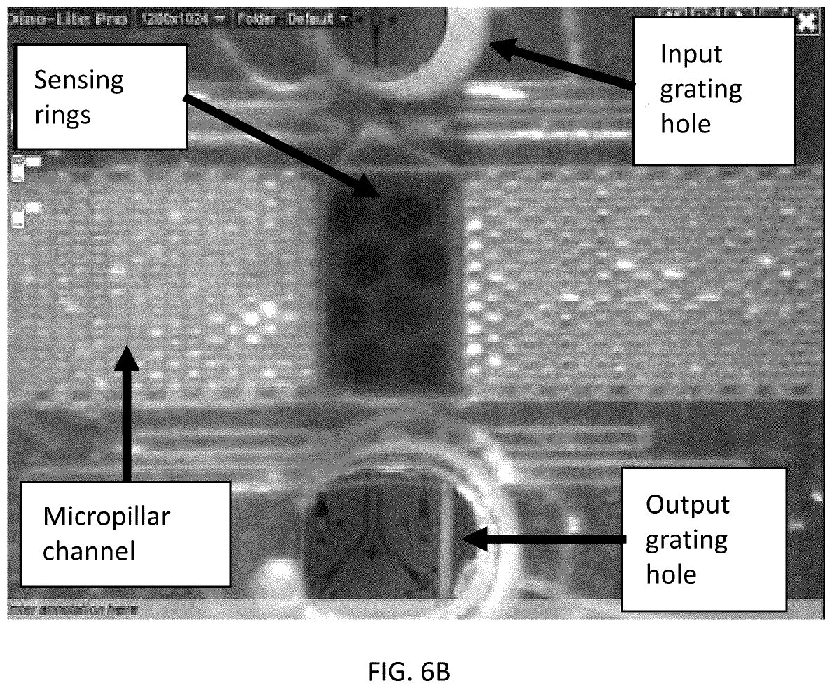

PICs were integrated with an inexpensive microfluidic card designed to provide passive flow of sample liquids to the photonic chip for analysis. For precise control of analyte delivery, the microfluidic card requires a sample introduction zone, channels to direct fluid flow, a detection zone where the PIC chip comes in contact with fluid, and a wicking zone to serve as a fluid sink and enhance flow through capillary or evaporative action. An image of the PIC positioned at the detection zone is shown in FIG. 6A.

Polystyrene micropillar fluidic cards were first treated with oxygen plasma for ten minutes to increase the hydrophilicity of the fluidic channels (Plasmod Plasma System, Nordson Plasma Systems, Concord, CA). Double-sided, 57 μm-thick adhesive tape (467MP, 3M, St. Paul, MN) was patterned using a laser cutter (Full Spectrum Laser, Hobby Series 20×12) to interface the fluidic card with a photonic chip. The adhesive covered the entirety of the micropillar channels, leaving small windows for the photonic gratings to be accessed with optical fiber signals, and for ring resonator sensors to interface with sample flowing through the channel (FIG. 6B). Additionally, a large inlet hole allowed access with a pipette for sample addition to the sample introduction zone. Patterned adhesive tape was added to the fluidic cards using a custom alignment device, and a strip of filter paper (Q1, Whatman, Little Chalfont, UK) was placed between the micropillar outlet channel and adhesive, to facilitate continuous flow once the channel had filled. Once the adhesive was applied to the fluidic card, photonic chips were manually aligned aided by a custom jig to the channel and optical-access ports.

FIG. 6A shows a PIC mounted to a fully assembled micropillar card with adhesive tape and Whatman wicking pad. Sample is applied in the sample zone, which flows under the PIC and into the wicking zone reservoir. A Whatman wicking pad enables assays to be run with larger sample volumes than the current micropillar reservoir allows. FIG. 6B shows how the multiplex PIC is aligned to the input and output optical pass-though, as well as the microfluidic channel of the micropillar card. The PIC is affixed to the card with adhesive tape that includes pass-throughs for the gratings and the microrings. The microring pass-through extends just beyond the width of the sensing trenches and the microfluidic channel to prevent leakage.

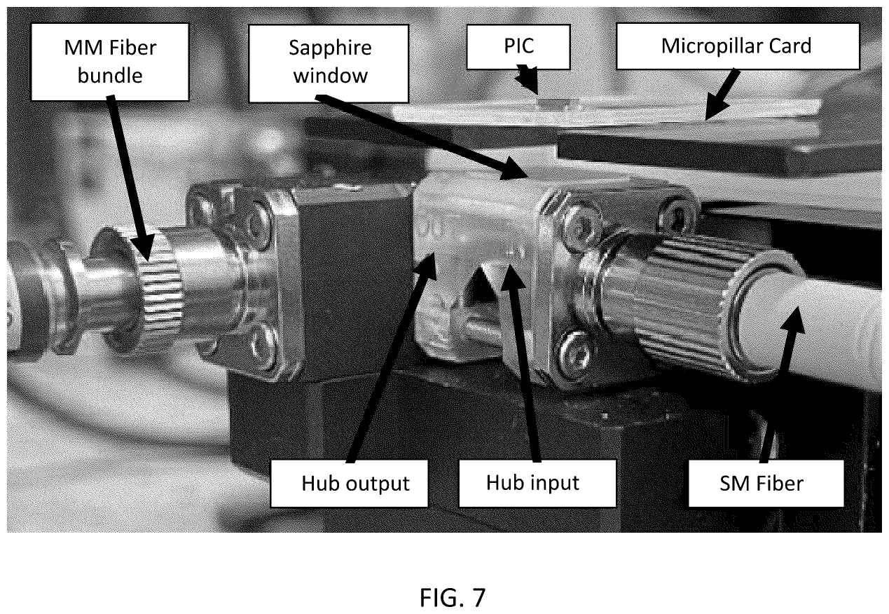

The assembled assay consumable was aligned to an optical source, which comprised a custom multiplex optical element (Syntec Optics, Rochester, NY) that enabled light to be coupled to and from the photonic grating couplers from below the micropillar card. A side view of the multiplex optical hub testing apparatus is shown in FIG. 7. The output optical design has been configured to enable interface with four gratings instead of one. Input light arrives via singlemode (SM) fiber on the right and passes through the input optics of the hub to the PIC. A ray diagram of the modified output optical design is shown in FIG. 4.

In some embodiments alignment of the multiplex hub to the PIC requires an infrared microscope positioned directly above the hub lens system in the path of the IR beam. Since the silicon PIC is transparent to infrared light, the IR beam scatters off the trench and grating features on the PIC as it passes through to the camera. The IR beam is aligned to input grating of the PIC.

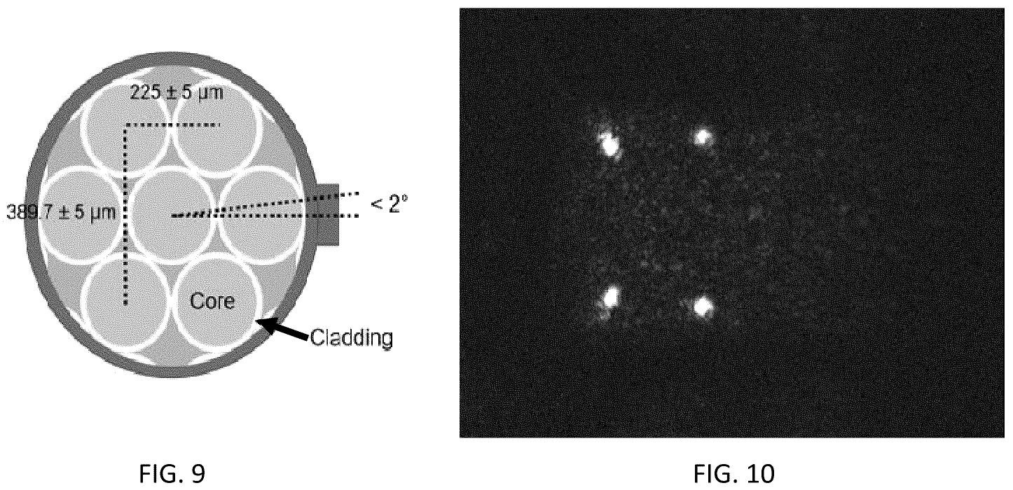

The modified output lens system is designed to image the four output gratings of the multiplex PIC (FIG. 10) to the upper two and lower two fibers of a custom multimode fiber bundle shown in FIG. 9. FIG. 9 shows an end-on diagram of the custom 7-fiber bundle with hexagonal close-packing. The two uppermost and lowermost multimode fibers collect light from the four output gratings of the PIC. FIG. 10 shows an IR micrograph of the four output gratings of a PIC with the light coupled through the input. Output gratings of the multiplex PIC correspond to the illuminated gratings in the IR micrograph.

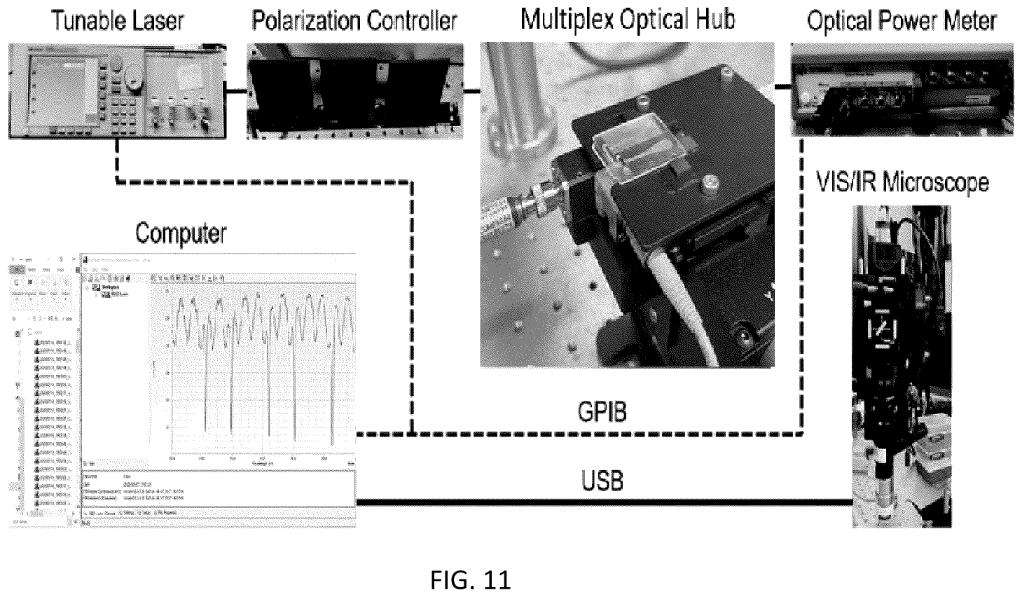

A schematic of the multiplex optical hub apparatus is presented in FIG. 11. A tunable laser source (Keysight 81606A) is directed through a polarization controller (Thorlabs FPC561 with SMF-28 FC/PC connectors) to obtain linearly polarized light with TE orientation relative to the silicon nitride waveguide. Light is directed though the input of the optical hub and focused on the input grating of the PIC. Output light from the four PIC output gratings is collected by the optical hub and directed through a custom fiber bundle (IDIL Optics) of multimode fibers (Thorlabs FP200ERT) to four channels of the optical power meter (Keysight N7745A). Alignment of the PIC to the optical hub is facilitated by a dual-camera VIS/IR microscope. A 5× IR objective lens (Mitutoyo Plan Apo NIR 46-402) with on-axis illumination directs light though a longpass dichroic mirror (Thorlabs DMLP950R) to either the IR camera (WiDy InGaAs 650) or VIS CMOS camera (Thorlabs DCC1645C). Proper alignment is confirmed by IR micrograph and resonance spectra.

The tunable laser and optical power meter were connected to a computer via general-purpose interface bus (GPIB) and were controlled by the Insertion Loss software of the Keysight Photonic Application Suite (N7700A). Measurements were performed by repeated wavelength scans in the vicinity of resonance signals from the control and probe rings (6 nm scans). The resonance redshift is proportional to the binding of material to the ring surface. Specific shift due to capture of target analyte is calculated by subtracting the redshift of the control ring from that of the probe ring, using a data analysis protocol discussed below.

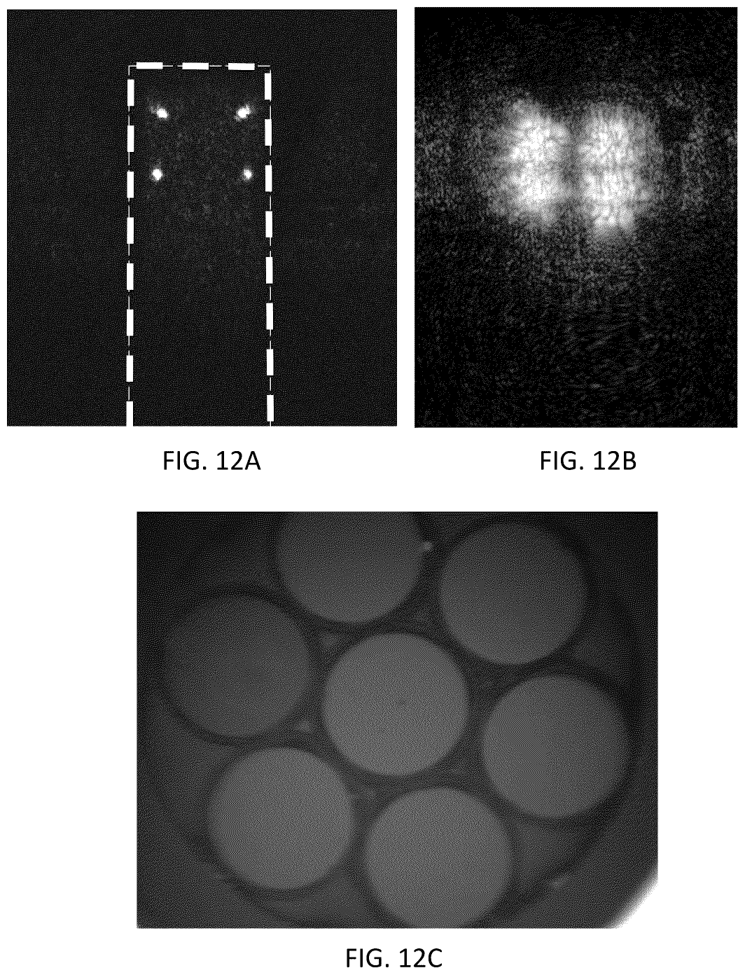

After initial assembly of the multiplex hub the proper alignment of the individual components to produce spectra was verified. The input grating of the PIC was aligned to the input wavefront, and the z-axis alignment was optimized by maximizing the light emitted by the output gratings. An IR micrograph of the light emitted by these four gratings is presented in FIG. 12A. Next, the output alignment was verified by coupling light in the reverse direction through the multimode fibers of the output fiber bundle. This aided in the initial alignment of the hub by observing the overlap between the output light from the gratings, and light emitted from the fiber bundle. The initial configuration was rotated 11-degrees and translated ˜200-microns farther from the input grating than required, as shown in FIG. 12B. Inspection of the fiber bundle revealed that the fibers were not properly aligned with the key of the connector, resulting in the rotational misalignment (FIG. 12C). This issue was solved by replacing the fiber bundle with one that was correctly manufactured.

FIG. 12A shows an IR micrograph of light emitted from output gratings of a multiplex PIC with the input grating aligned to the hub. Dashed line indicates the perimeter of the PIC. FIG. 12B shows light routed in reverse through the output multimode fibers of the fiber bundle reveals their alignment relative to the PIC (black outline). Here, the bundle is clearly misaligned along the bundle axis. FIG. 12C shows an inspection of the fiber bundle revealing it was misaligned by 11-degrees relative to the key of the APC connector.

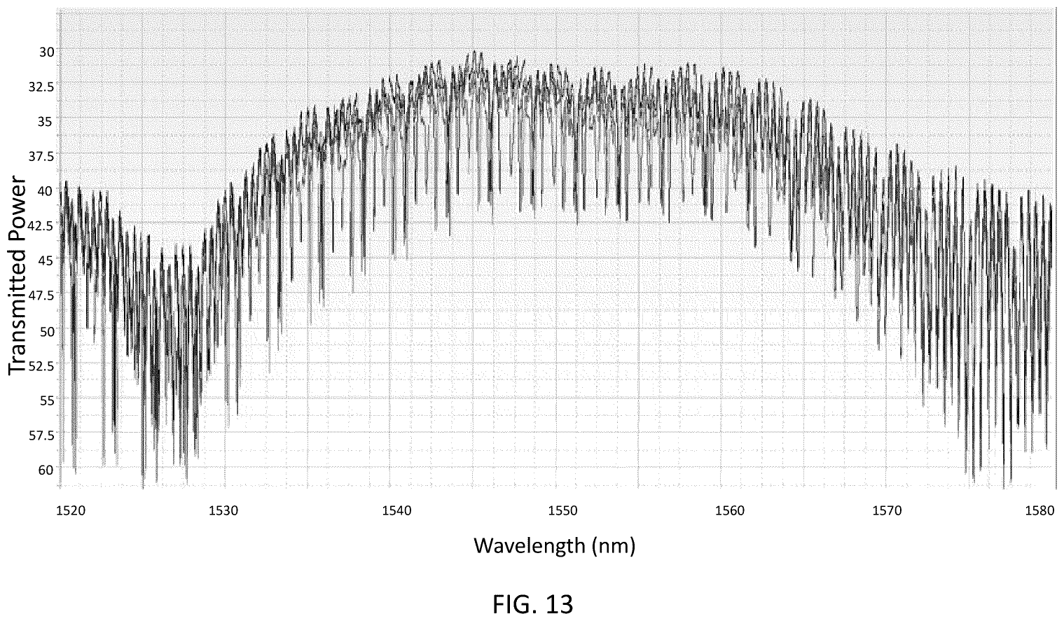

Decreasing the 200-micron translational misalignment required removing the collar of the FC ferrule connector to provide additional goniomic degrees of freedom. Then the separation between the input and output wavefronts was decreased by carefully tightening the lower two screws of the input bulkhead against the optical hub. The resulting spectra from the properly aligned hub are presented in FIG. 13. Four spectra of equal peak intensity provide access to the resonance of eight individual sensing rings. FIG. 13 shows a spectral scanned from 1520-1580 nm of a multiplex PIC aligned to the hub. All four output channels (blue, red, green, cyan) were captured equally by the hub. The arch shape of the spectra reflects the wavelength-dependence of the grating, optimized for 1550 nm light.

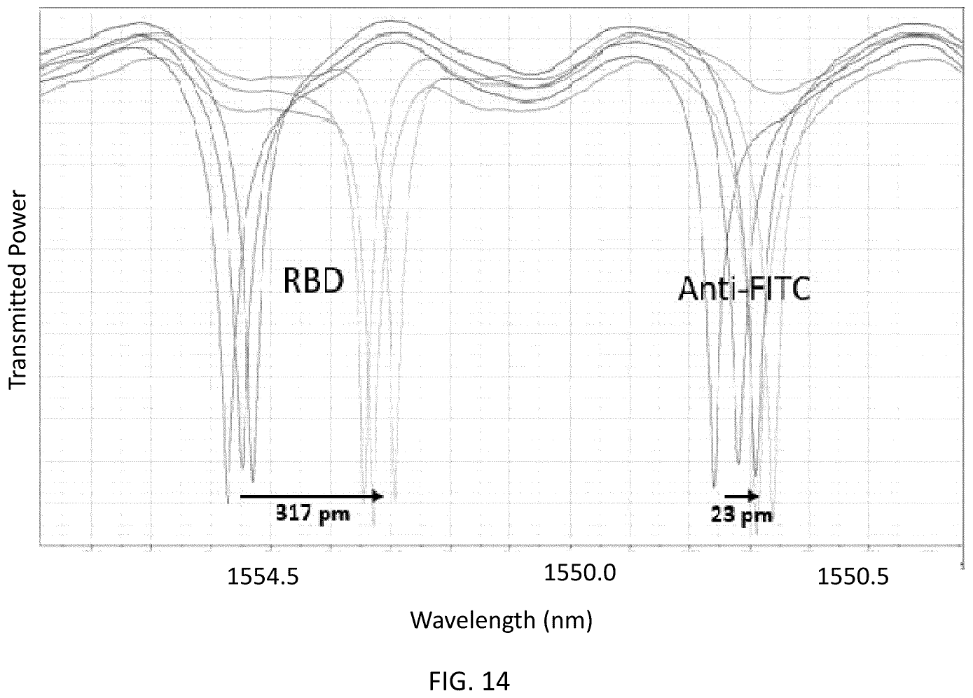

Once the device was aligned, 6 nm spectra were taken continuously at 1 μm resolution, generally centered around 1550 nm, with each spectral sweep taking about 6 seconds. All spectra were automatically saved for analysis. Once a spectrum was acquired after alignment, the experimenter sequentially added samples as follows. For data reported in FIG. 14, first, 15 μL of a 10% BSA in assay wash buffer (AWB), was added. This step served three purposes: first, to wash off the stabilizer (StabilGuard) and expose the antigen-functionalized rings; second, to allow the peak from each ring to equilibrate to an environment with a similar bulk refractive index to that of the human serum samples; and third, to block nonspecific binding sites. Once the spectra had stabilized, indicating removal of StabilGuard, the serum sample to be measured was added. The sample was diluted 1-to-5 in 10% BSA in AWB. For all other experiments, as indicated, the procedure was identical except that the 10% BSA in AWB diluent was replaced with AWB alone.

Collected spectra were processed automatically through a custom pipeline of MATLAB (MathWorks, Natick, MA) and Python scripts described previously (Cognetti et al., 2021). The output spectra for each channel were collected simultaneously and stored in the same file. Minor modifications were made to the pipeline to accommodate multiple output channels. Briefly, spectral features including peak location, peak height, quality factor, chi-squared values and peak fitting parameters were extracted by fitting the data with a Lorentzian function. The output spectra for each waveguide were saved separately as individual columns within the same file, enabling independent analysis.

Typical spectra from a sensing experiment are presented in FIG. 14. The measured quality factors typically exceeded 5×10⁴, which is half what was observed in previous experiments utilizing a singleplex hub. This was to be expected since the diameter of the multiplex rings had to be reduced to fit 8 rings within the footprint of the same 1×4 mm PIC. The benefit to a smaller ring diameter is the corresponding increase to the free spectral range (FSR) between sequential resonance peaks. The FSR for the multiplex hub ring was 2.517 nm at 1555 nm vacuum wavelength, compared to 2.122 nm for the singleplex ring. With extinction ratios exceeding 20 dB under aqueous cladding, these rings were well designed to enable sensing.

FIG. 14 is a plot showing antibody sensing spectral shifts for an anti-RBD measurement. Each ring has a corresponding resonant wavelength, at which is seen as a trough in transmitted power. The peaks on the left correspond to the RBD peptide-functionalized rings, and the peaks on the right to the anti-FITC-functionalized rings. One RBD and one anti-FITC peak are not present in the spectra because the rings were damaged during the trench etch process and did not yield sufficient resonance signal-to-noise. With the addition of a human serum sample, diluted 1-to-5 in 10% BSA/AWB, the left peak shifts as antibodies bind to the ring (mean: 317 pm, std. error: 38 pm), while the anti-FITC ring shifts much less, due to nonspecific interactions with serum proteins (mean 22 pm, std. error: 26 pm). The net shift, corrected for non-specific binding by subtracting the negative control shift is 295 pm.

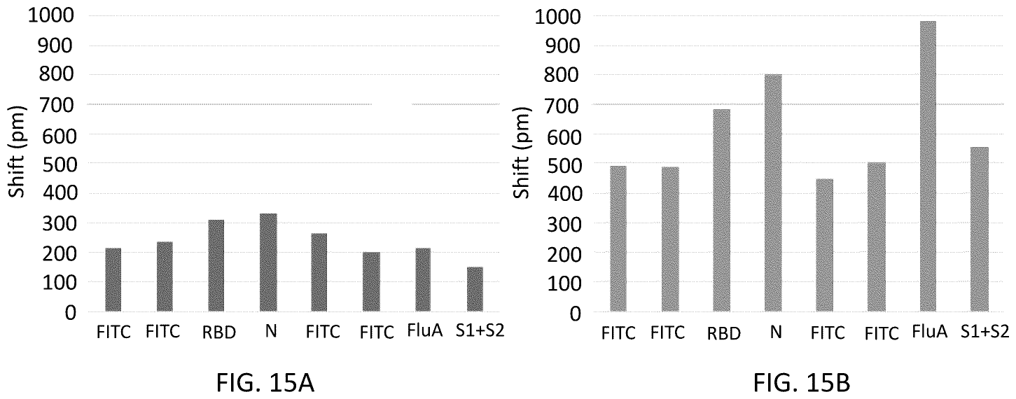

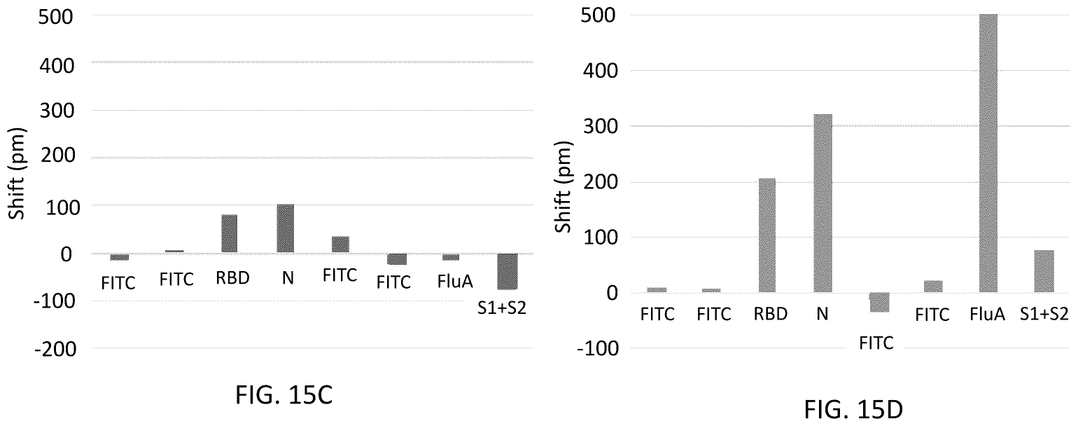

Serology results were then compared for a convalescent serum sample from an individual who tested PCR-positive for SARS-CoV-2 diluted 1-to-5 in either 10% BSA/AWB or AWB alone (FIGS. 15A-15D). FIG. 15 A shows raw shifts for 10% BSA/AWB diluent, FIG. 15B shows raw shifts for AWB diluent, FIG. 15C shows anti-FITC corrected shifts for 10% BSA/AWB diluent, and FIG. 15D shows anti-FITC-corrected shifts for AWB diluent. When comparing FIG. 15A and FIG. 15B, there is a clear increase in the magnitude of the response for all rings, including the anti-FITC controls, when AWB is used alone. This may be understood as a bulk shift due to the greater difference in total protein concentration between AWB and 1-to-5 dilution of serum in AWB, compared to 10% BSA/AWB and 1-to-5 dilution of serum in 10% BSA/AWB. 10% BSA is already a very high concentration of protein, and the dilution of serum has less effect on the total background protein concentration than it would in AWB alone. When comparing the anti-FITC-corrected shifts that account for background and non-specific binding, in FIG. 15C and FIG. 15D, of the SARS-CoV-2 antigens the top two responders were N and RBD. This is consistent for both diluents and in-line with expectations, because a large N response is typically seen in samples from individuals who have tested PCR-positive. However, the shifts observed with AWB as a diluent were 3-fold greater in magnitude than for 10% BSA/AWB. Likewise, the response to S1+S2 that would be expected for a convalescent sample is present with AWB and absent with 10% BSA/AWB. Finally, this sample is known to be positive for antibodies against influenza A H3N2 hemagglutinin (A/Switzerland/9715293) (FluA). With 10% BSA/AWB, the assay fails to capture the expected positive FluA response, but with AWB it is the strongest responder (FIG. 5.10(d)). From this comparison, AWB diluent is a better performer, yielding expected outcomes with greater contrast between responders and control.

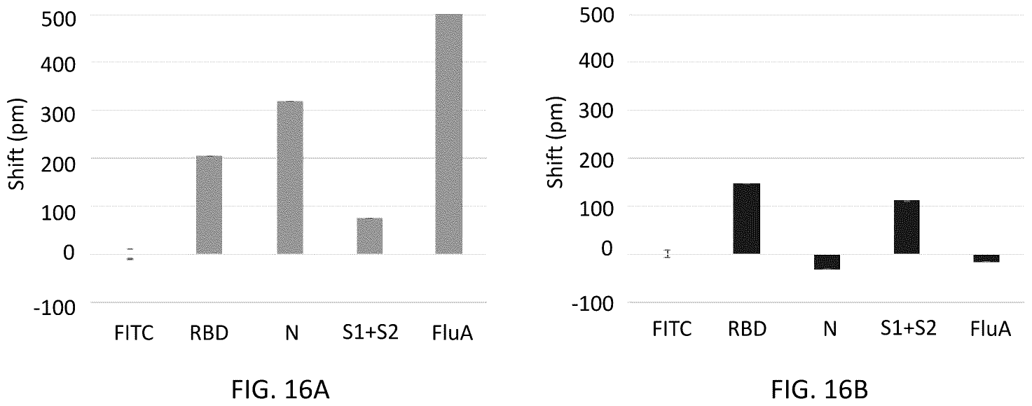

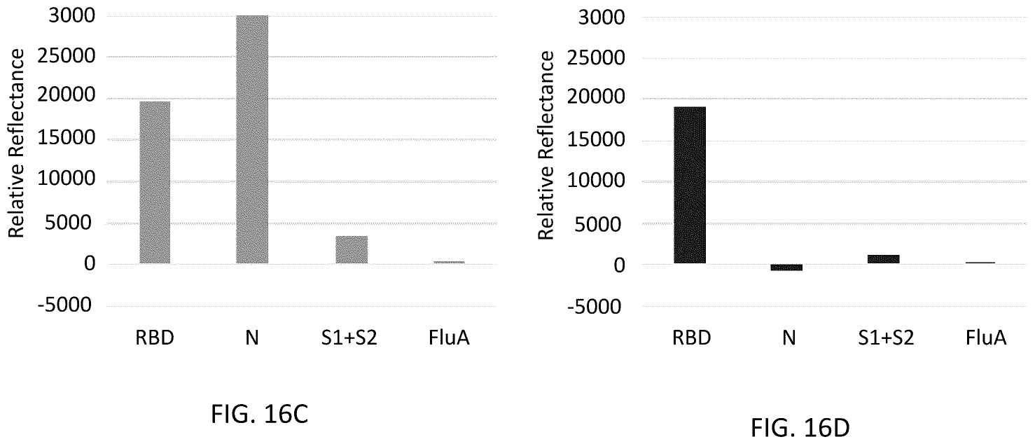

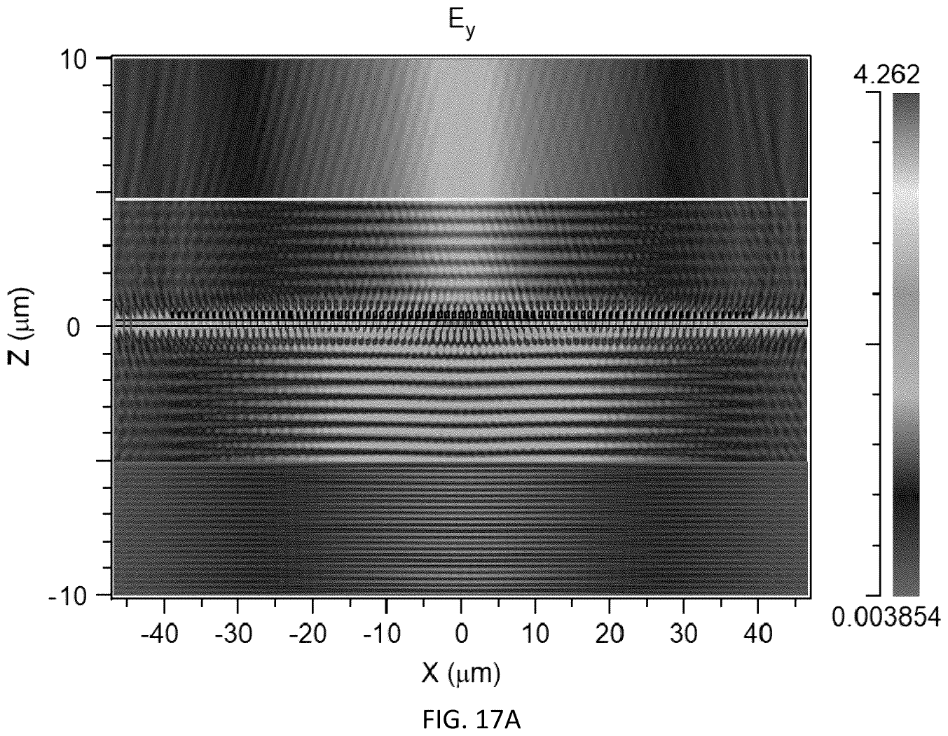

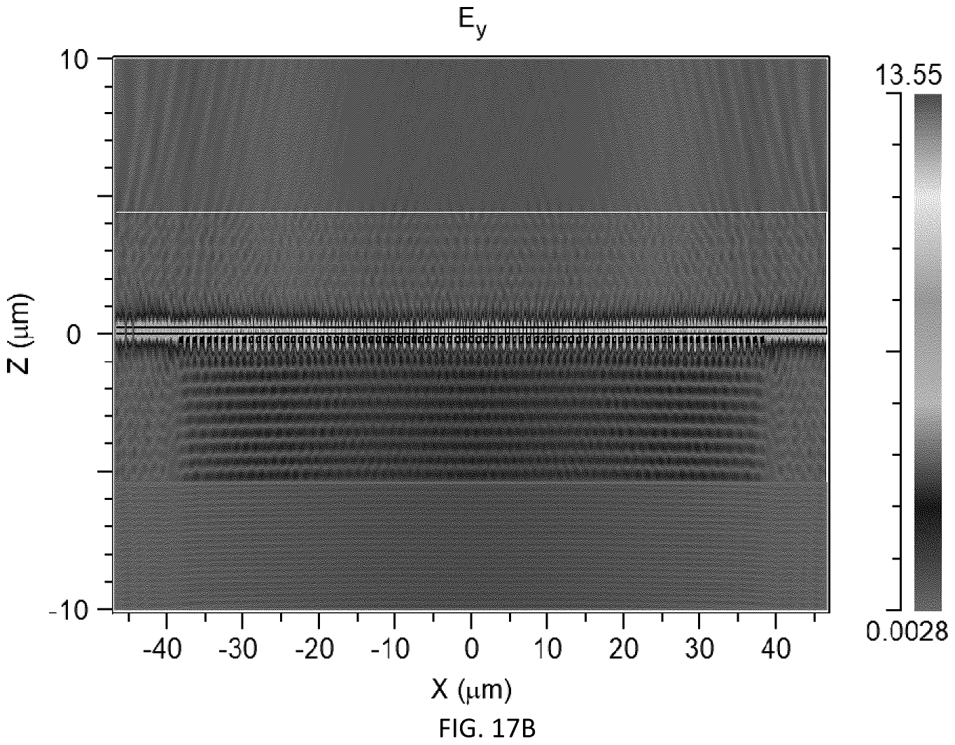

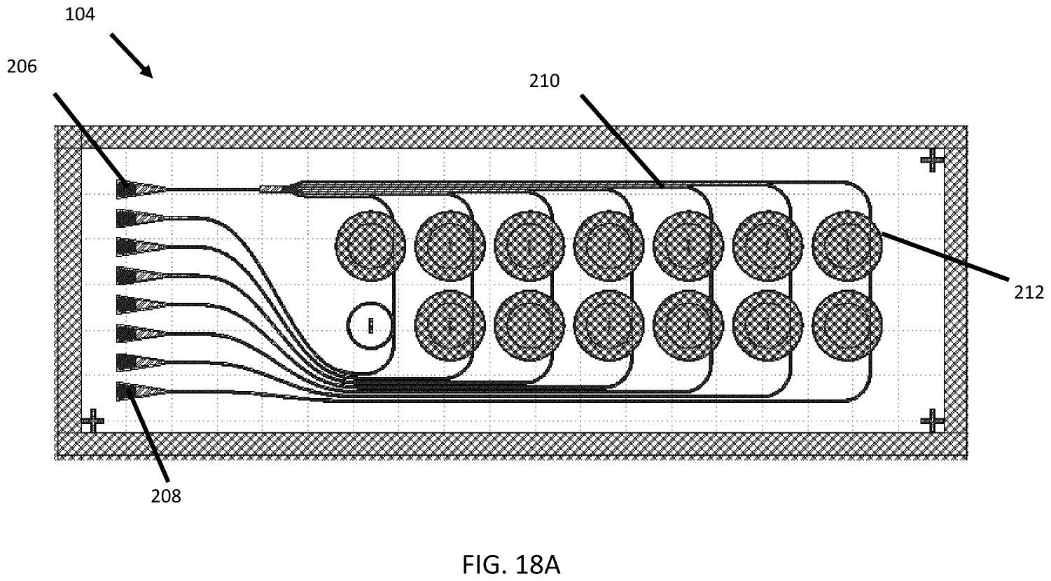

Next, serology results were compared for a sample from a convalescent individual with that from a vaccinated individual who had not tested positive for SARSCoV-2. These results were cross validated with those from ZIVA, a commercial high throughput arrayed imaging reflectometry platform. Based on previous performance, the diluent used for these samples was AWB. Results from the multiplex hub and ZIVA are presented in FIGS. 16A-16D. FIGS. 16A-16D are serology results from the multiplex hub and ZIVA (arrayed imaging reflectrometry) for samples from two individuals: (1) a convalescent individual who tested PCRpositive for SARS-CoV-2 and had not been vaccinated (convalescent), and (2) an individual who had not tested PCR-positive and had their second dose of vaccine one month prior to providing the sample (vaccinated). RBD, SARS-CoV-2 receptor binding domain; N-protein, SARS-CoV-2 nuclear peptide; S1+S2, SARS-CoV-2 S1+S2 extracellular domain; FluA, influenza A H3N2 hemagglutinin (A/Switzerland/9715293); FITC: anti-FITC negative control. FIG. 16A shows multiplex hub results for the convalescent sample, FIG. 16B shows multiplex hub results for the vaccinated sample, FIG. 16C shows ZIVA results for the convalescent sample, and FIG. 16D shows ZIVA results for the vaccinated sample.

As before, for the convalescent sample, the response to influenza A was most pronounced, with a 502 pm shift, followed by N peptide at 318 pm. The strong N-protein response is consistent with expectations for an individual who recovered from infection. The RBD response was 203 pm and the response for S1+S2 was less than half as strong at 74 pm. The standard error of the anti-FITC negative control response was 10 pm. Overall, the relative response to SARS-CoV-2 peptides attained from the multiplex hub compared well with the results from ZIVA. On the other hand, while the Flu A response from the multiplex hub was significant, the modest response on ZIVA was ruled negative for this sample, but positive for three subsequent samples from the same individual (data not shown). For the vaccinated sample, the response to RBD was most pronounced, with a 145 pm shift, followed by S1+S2 at 110 pm, but the response to N-protein was negative (FIG. 16B). While the standard error of the anti-FITC negative control response was 8 pm. This pattern is one of the key differentiators between convalescent and vaccinated samples. Individuals who were vaccinated but were never infected have not been exposed to the N-protein. This individual was known to have never been exposed to influenza A (A/Switzerland/9715293), so the clear negative result is in-line with expectations. When compared to ZIVA, these results were identical in outcome, if not relative magnitude (FIG. 16D). The measured response for RBD and S1+S2 were 19071 and 1072 relative reflectance units, respectively, and both were ruled positive. Meanwhile the response to N-protein and influenza A were both negative.

When an assay is performed using human serum samples, the choice of sample diluent can play a significant role in both the performance and reproducibility of the assay. Here, the SARS-CoV-2/influenza A serology results showed a marked improvement when AWB was used alone, instead of 10% BSA/AWB. However, more samples must be run to establish the effect of AWB on assay reproducibility. Further studies of alternative diluents may continue to improve both the performance and reproducibility of this multiplex assay with serum samples.

Multiplex serological assays can play an important role as a pandemic becomes an endemic. As novel variants continue to erupt into the population it will be important to understand an individual's cross-immunity profile to new variants. Such studies could aid the choice of variants to be included in future booster vaccines. Here, the multiplex capability of this assay was used to distinguish an individual with natural immunity from a vaccinated individual, by the presence of a response to N-protein. The assay further differentiated individuals with and without immunity to a particular strain of influenza A.

A critical issue for a photonic biosensor is that of how light is coupled into the photonic integrated circuit (PIC). One possibility is an on-chip light source, but these require expensive fabrication processes. The second is to use edge coupling, but this requires either alignment to an external fiber array, or direct attachment of optical fibers, a very expensive and slow process. The third possibility is to use grating couplers. While grating couplers allow for light to be coupled into the PIC from various angles (depending on how the coupler is designed) above the chip, things become complicated for a biosensor to be used on a human sample. Since human samples typically involve aqueous solutions, a gasket must be used to isolate the sample from the area of the chip where the grating coupler is. This increases the complexity of the measurement system, and also significantly increases the cost of the sensor, since cost is directly related to the area of the chip. We have developed an approach to address these issues.

In order to solve the problem, the fact that the substrate silicon of a PIC is transparent to infrared light was considered. As such, it was decided to determine if it was possible to configure a grating exactly the opposite of current teaching for grating coupler design. This allows for coupling light from the back side of the chip, through the substrate. The data presented below indicates that back-side coupling is feasible, albeit with low efficiency, using a grating coupler designed for “normal” front-side coupling. Since this method is particularly useful for photonic biosensors, preliminary data is provided showing successful use of back-side coupling in this context. Simulations are also shown for grating couplers designed for optimized back-side coupling.

Typical photonic gratings layers are patterned above the substrate, and light is coupled from an optical fiber or free-space optic positioned above the grating. Numerous approaches have been reported to improve grating efficiency by minimizing interaction between incident light and the substrate such as through-substrate concepts for coupling light into a grating and/or additional backside structures to improve efficiency by shaping the beam for interaction with the grating.

Modeling of backside coupling was performed to a typical optical grating geometry is shown in FIG. 17A, where a state-of-the-art photonic grating for coupling light from above the surface of the substrate into a waveguide is modeled. When illuminated from beneath the substrate, 5.9% is absorbed by the grating while 66.4% is transmitted and 27.6% is reflected. FIG. 17B illustrates improved performance of a grating optimized for backside through-substrate coupling where an in house through-substrate grating is modeled. When illuminated from beneath the substrate, 65.8% of the light is absorbed by the grating while 18.1% is transmitted and 15.9% is reflected. This is an eleven times improvement over a state-of-the-art grating coupler.

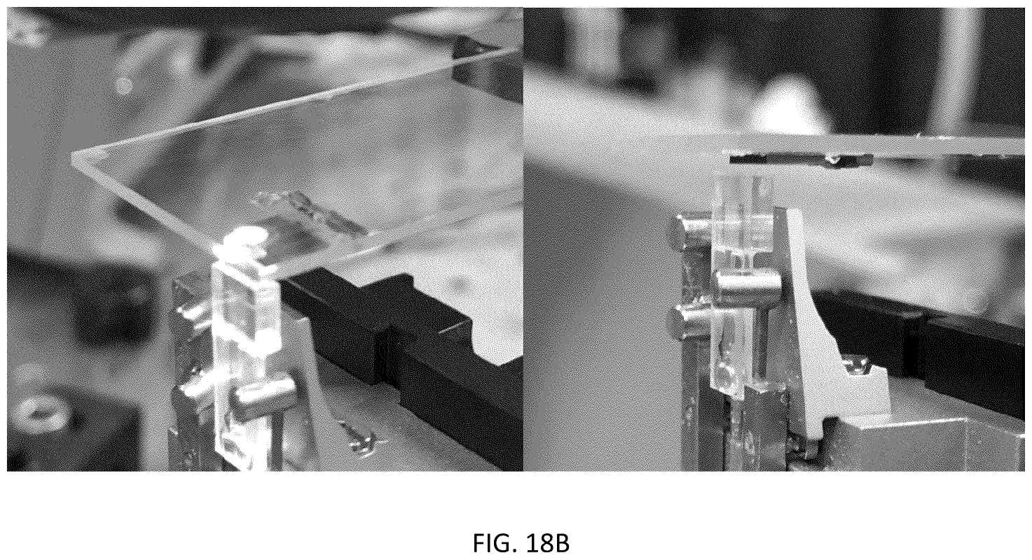

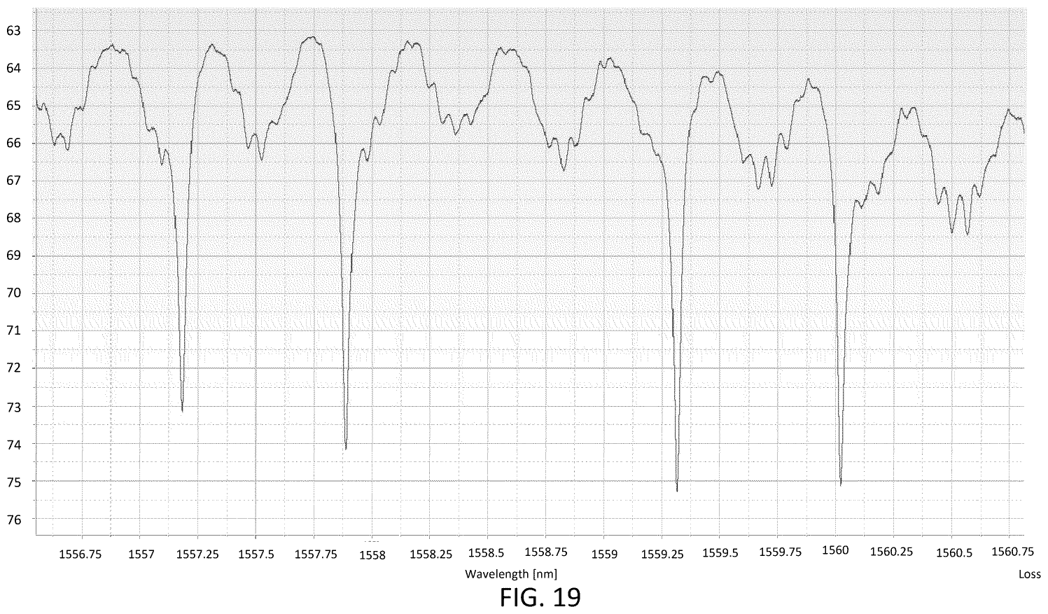

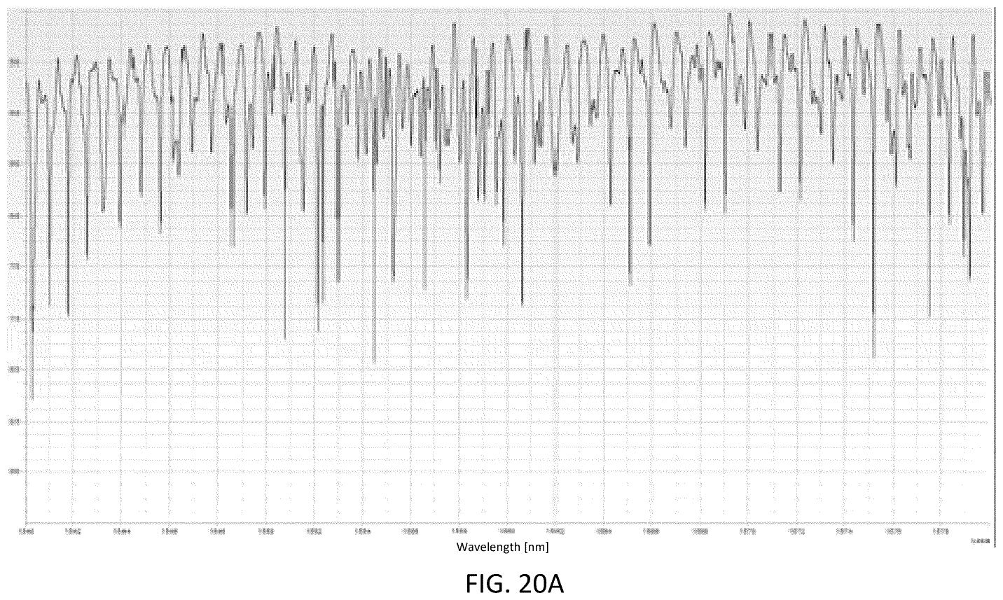

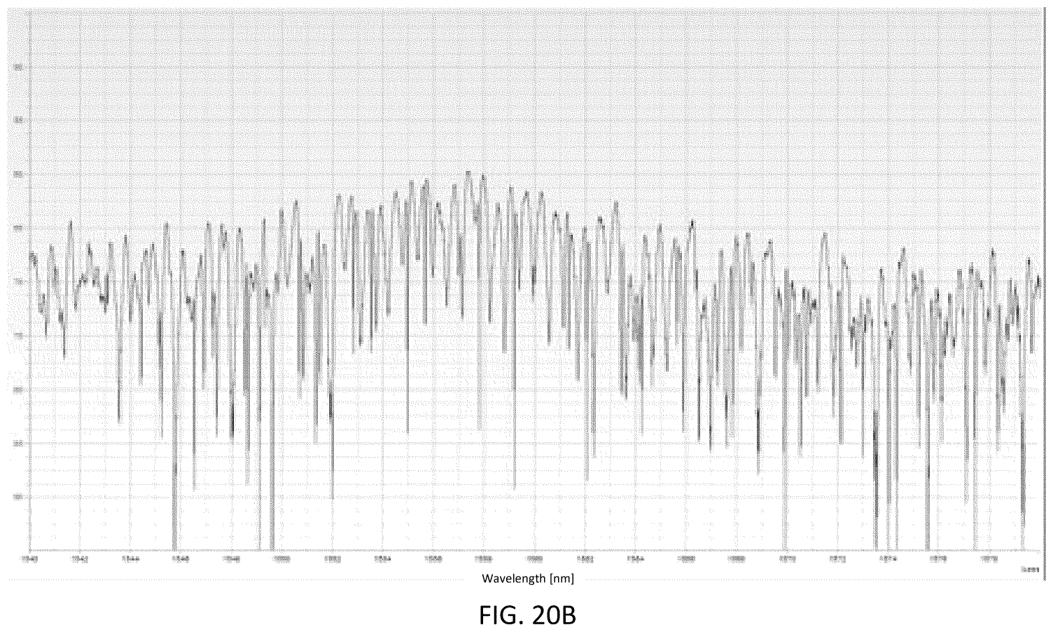

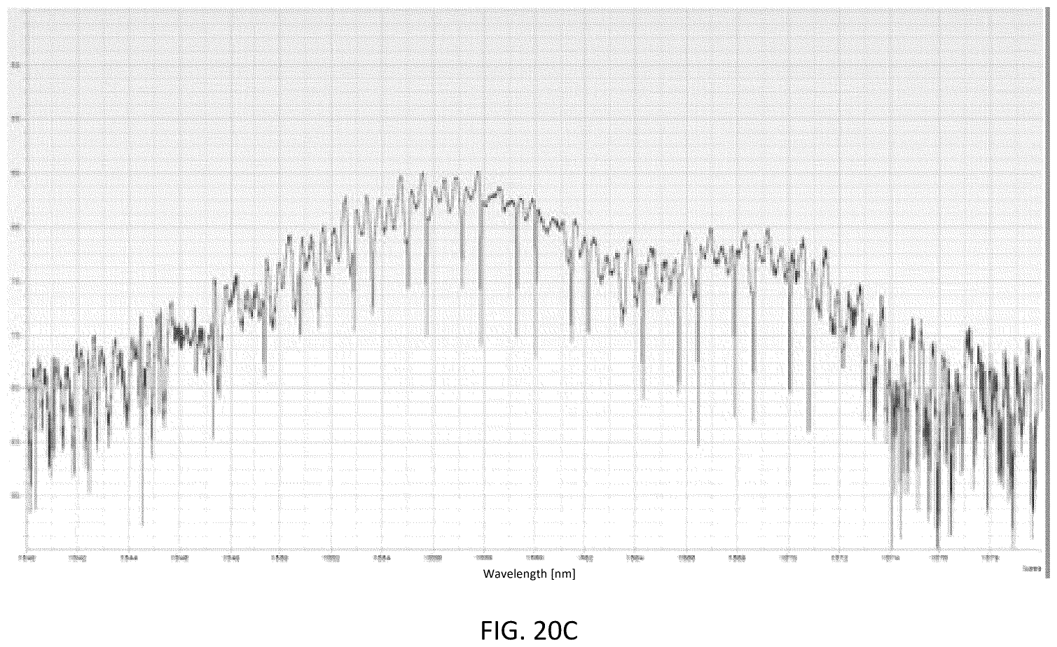

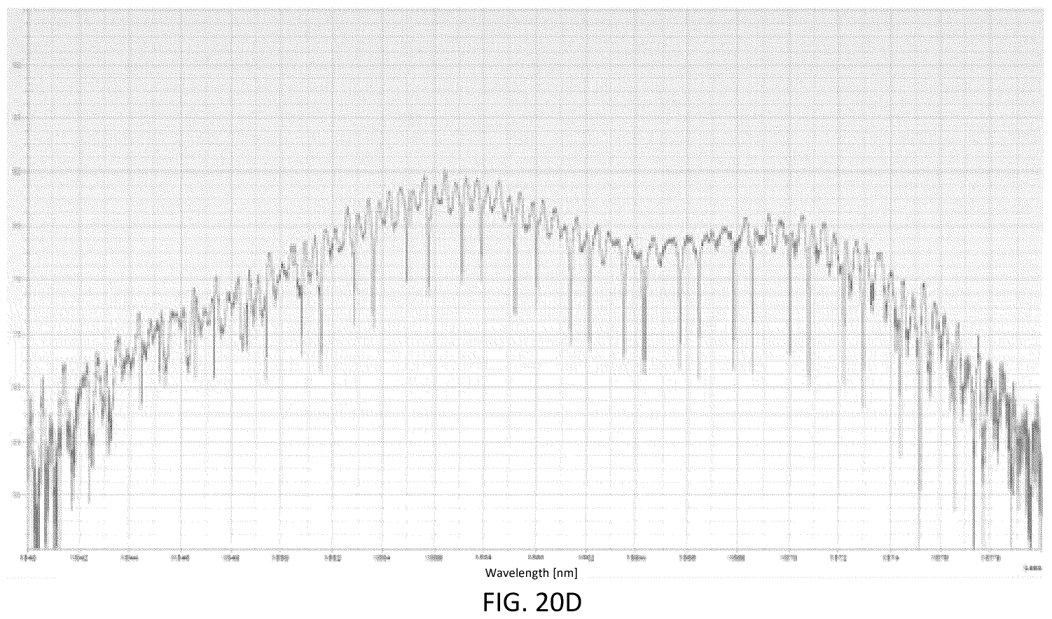

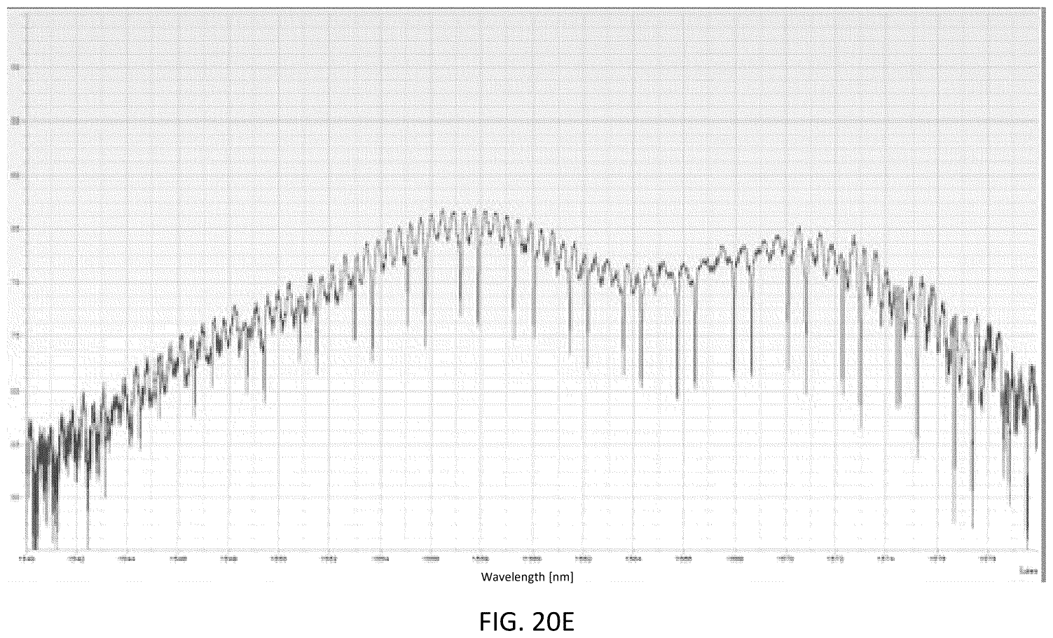

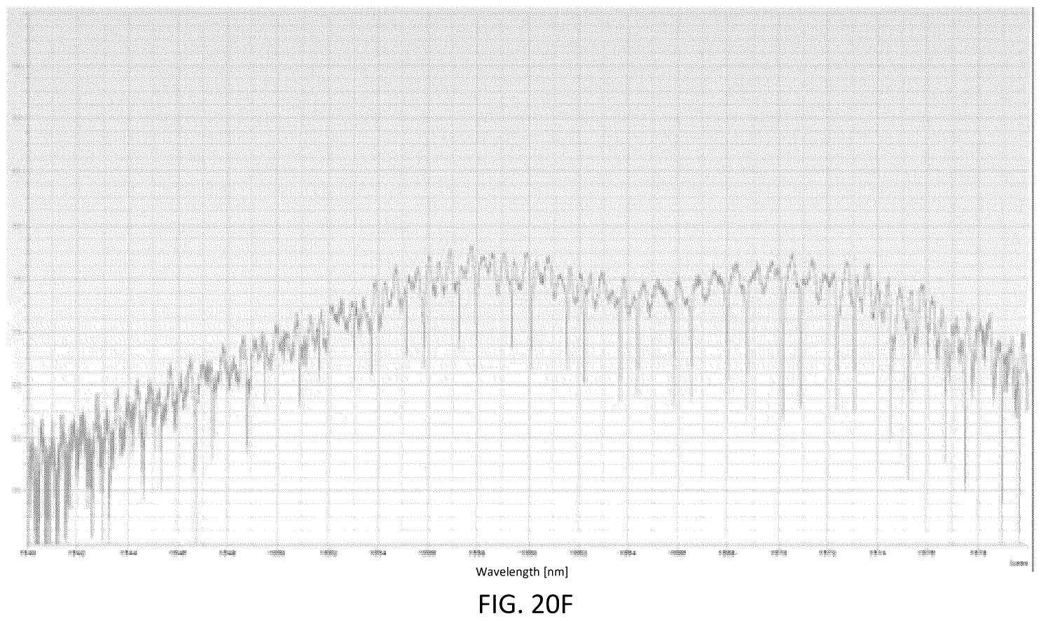

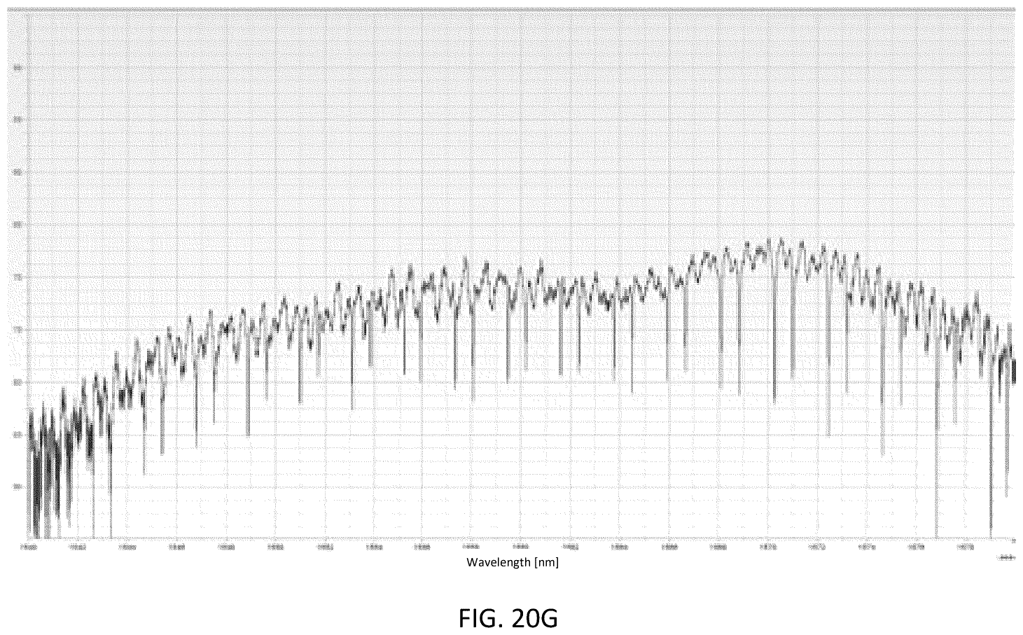

Preliminary testing was then performed as shown in FIGS. 18A and 18B. PICs integrating backside gratings and ring resonators for biosensing were designed and fabricated, as illustrated in the layout in FIG. 18A. A fiber array, oriented perpendicular to the underside of the PIC was used to couple light into and out of the gratings (FIG. 18B). Resonance spectra collected from each of the seven output gratings is presented in FIG. 20A through 20G. FIG. 19 zooms in on a single free-spectral range of both rings on a single bus waveguide.

FIG. 18A shows the layout of the exemplary experimental multiplex photonic chip. A single input grating 206 and seven output through-substrate gratings 208 were arranged in a 127 micron pitch array. Guided light is divided equally by a 7-way photonic splitter and interacts with 7 banks of microring resonators 212, on which covalently-linked probe molecules capture specific target analytes. FIG. 18B shows the fiber array with SMF-28 fibers on 127 micron pitch v-groove substrate, coupling laser light into and out of gratings through the underside of the silicon chip.

FIG. 19 shows measured resonance signal from output grating 5 of through-substrate grating array, with two sequential resonances from two different rings on the same bus waveguide. FIGS. 20A through 20G show Measured output spectra from through-substrate coupling to output gratings 1-7, respectively.

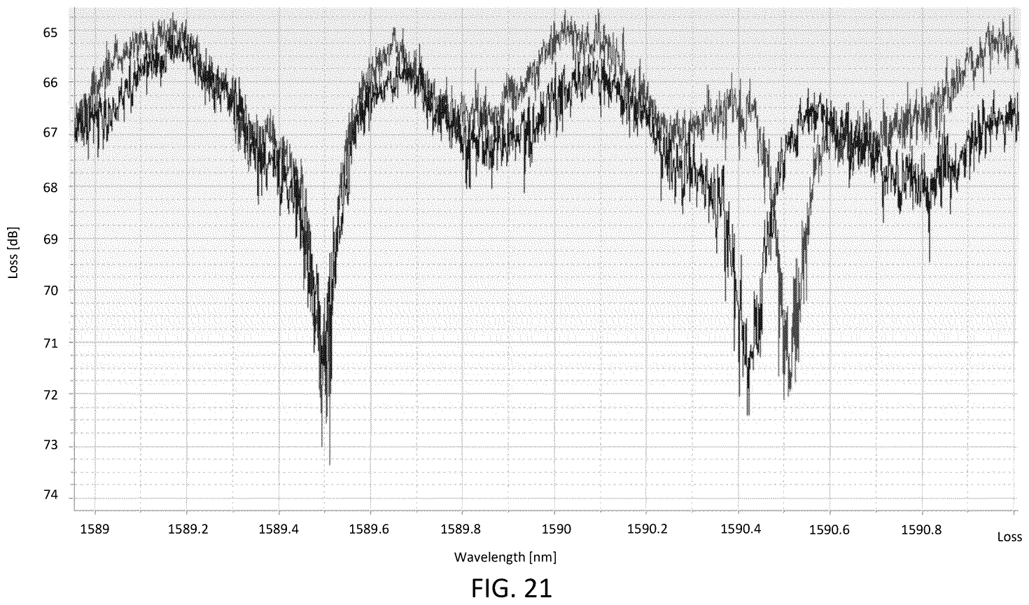

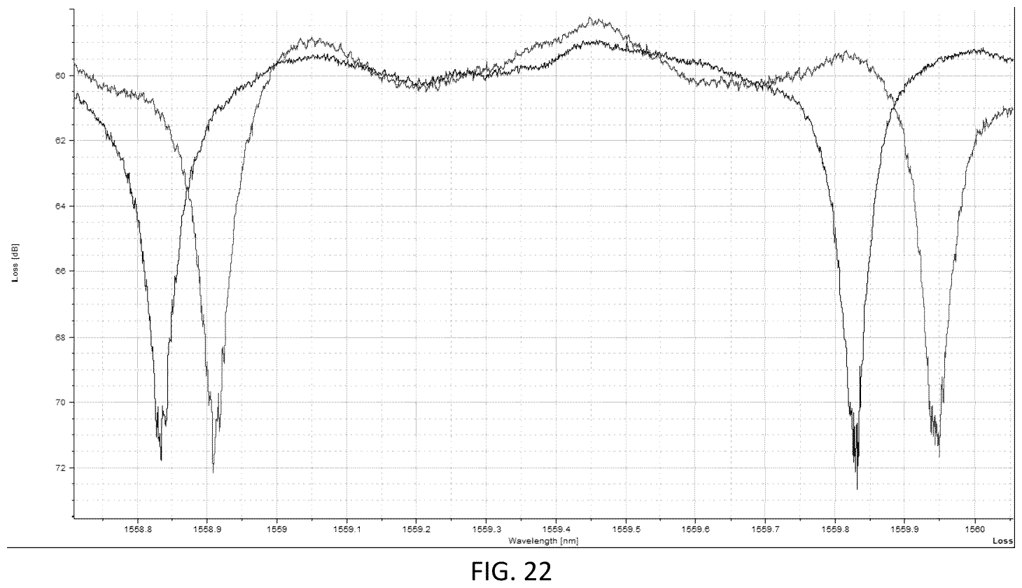

FIG. 21 shows C-reactive protein biosensing data for through substrate coupling for a single sensor pair. The blue trace is the initial control sample spectrum, while the green trace is a sample spiked with 500 ng/mL C-reactive protein. Left spectral notches represent negative control sensors, and right notches represent experimental detection sensors devices. A ˜90 μm shift is observed due to binding.

FIG. 22 shows C-reactive protein biosensing data for through substrate coupling for a single sensor pair. The blue trace is the initial control sample spectrum, while the green trace is a sample spiked with 100 ng/mL C-reactive protein. Left spectral notches represent negative control sensors, and right notches represent experimental detection sensors devices. A ˜24 μm shift is observed due to binding.

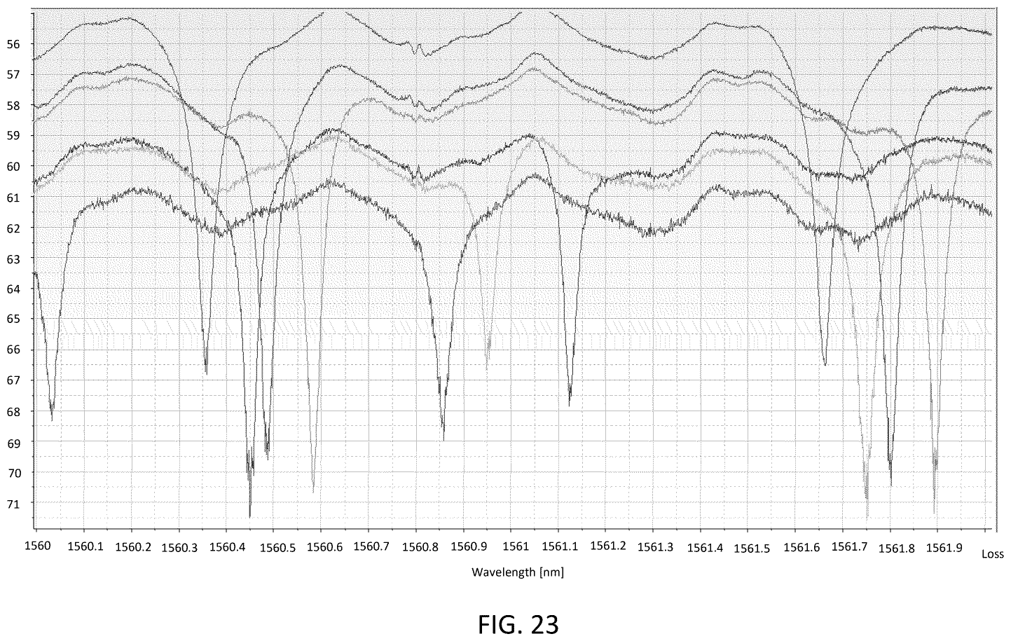

FIG. 23 shows backside coupling where a photonic chip was placed upon a microscope slide coverslip. Light was coupled through the coverslip and backside of the chip into the input grating and retrieved through the output gratings. The 6 Photonic sensor pairs were exposed to nanopore water.

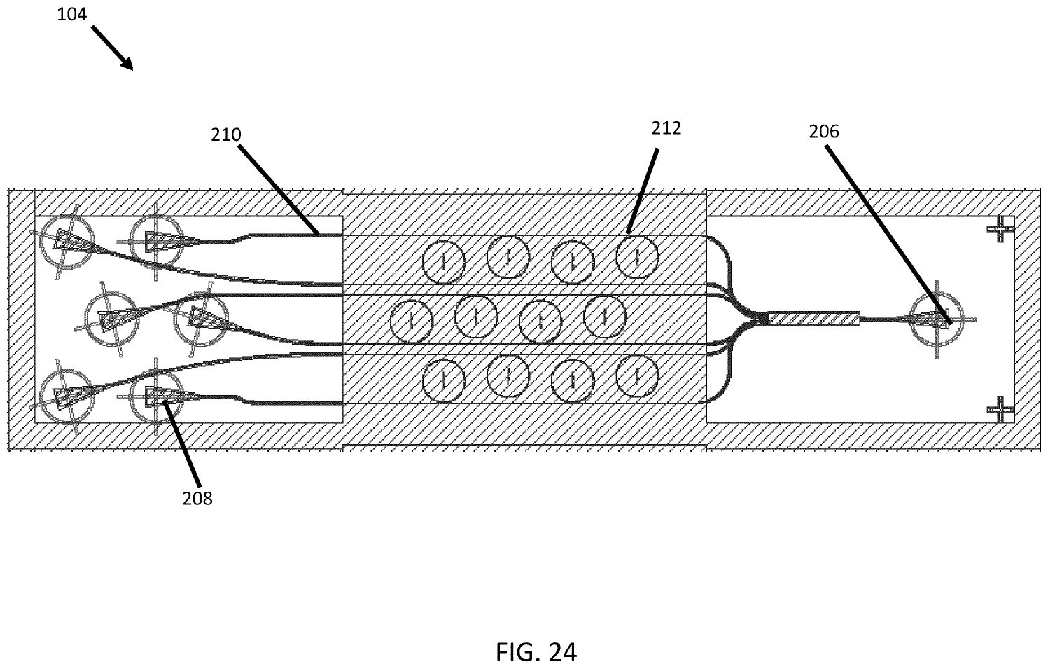

FIG. 24 shows the layout of another exemplary experimental multiplex photonic chip 104 including a single input grating 206 and six output through-substrate gratings 208. Guided light is divided by a photonic splitter and interacts with 12 banks of microring resonators 212, on which covalently-linked probe molecules capture specific target analytes. The multiplex photonic chips can include an suitable number of input gratings 206, output gratings 208, waveguides 210 and microring resonators 212 dependent upon the application of the photonic chip 104.

The following publications are hereby incorporated herein by reference in their entirety:
Cognetti, J. S., Steiner, D. J., Abedin, M., Bryan, M. R., Shanahan, C., Tokranova, N., Young, E., M. Klose, A., Zavriyev, A., Judy, N., et al. (2021). Disposable photonics for cost-effective clinical bioassays: application to COVID-19 antibody testing. Lab on a Chip 21, 2913-2921.
Dong, E., Du, H., and Gardner, L. (2020). An interactive web-based dashboard to track COVID-19 in real time. The Lancet Infectious Diseases 20, 533-534.
Fahrenkopf, N. M., McDonough, C., Leake, G. L., Su, Z., Timurdogan, E., and Coolbaugh, D. D. (2019). The AIM Photonics MPW: A Highly Accessible Cutting Edge Technology for Rapid Prototyping of Photonic Integrated Circuits. IEEE Journal of Selected Topics in Quantum Electronics 25, 1-6.
Hoffmann, M., Kleine-Weber, H., Schroeder, S., Krüger, N., Herrler, T., Erichsen, S., Schiergens, T. S., Herrler, G., Wu, N.-H., Nitsche, A., et al. (2020). SARS-CoV-2 Cell Entry Depends on ACE2 and TMPRSS2 and Is Blocked by a Clinically Proven Protease Inhibitor. Cell.
Wrapp, D., Wang, N., Corbett, K. S., Goldsmith, J. A., Hsieh, C.-L., Abiona, O., Graham, B. S., and McLellan, J. S. (2020). Cryo-EM structure of the 2019-nCoV spike in the prefusion conformation. Science 367, 1260-1263.
Yan, R., Zhang, Y., Li, Y., Xia, L., Guo, Y., and Zhou, Q. (2020). Structural basis for the recognition of SARS-CoV-2 by full-length human ACE2. Science 367, 1444-1448.
Zhou, P., Yang, X.-L., Wang, X.-G., Hu, B., Zhang, L., Zhang, W., Si, H.-R., Zhu, Y., Li, B., Huang, C.-L., et al. (2020). A pneumonia outbreak associated with a new coronavirus of probable bat origin. Nature 579, 270-273.
U.S. Pat. No. 10,073,091, “Lateral Flow Assay Device”
U.S. Pat. No. 9,689,870, “Assay Device Having Multiple Reagent Cells”
U.S. Pat. No. 9,389,228, “Lateral Flow Assay Devices for use in Clinical Diagnostic Apparatus and Configuration of Clinical Diagnostic Apparatus for Same”
U.S. Pat. No. 9,285,361, “Method for the Analysis of Circulating Antibodies”
U.S. Pat. No. 8,895,293, “Assay Device Having Uniform Flow Around Corners”
U.S. Pat. No. 8,821,812, “Method and Means for Creating Fluid Transport”
U.S. Pat. No. 8,409,523, “Assay Device Comprising Serial Reaction Zones”
U.S. Pat. No. 8,025,854, “Micro Fluidic Structures”
U.S. Patent Application No. 63/143,452, “Diagnostic Photonic Biosensor Methods, Apparatus, and System”
U.S. Pat. No. 8,494,315, “Photonic Integrated Circuit having a Waveguide-Grating Coupler”
U.S. Pat. No. 9,239,432, “Photonics grating Coupler and Method of Manufacture”
U.S. Pat. No. 9,453,969, “Grating-Coupler Assembly with Small Mode-Field Diameter for Photonic-Integrated-Circuit Systems”
U.S. Pat. No. 9,798,084, “Photonic Chip Grating Couplers”
U.S. Pat. No. 9,128,241, “Integrated Photonics Waveguide Grating Coupler”

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention.

1-31. (canceled)

32. A photonic biosensor apparatus, comprising:
a sample addition zone in fluid communication with a wicking zone and a sample detection zone, wherein the sample detection zone is between the sample addition zone and the wicking zone; and
at least one photonic integrated circuit disposed directly on a substrate, optically coupled to a light source and a photodetector via a fiber bundle, wherein the at least one photonic integrated circuit comprises:
at least one first grating coupler;
at least two second grating couplers;
at least one waveguide between the first grating coupler and the second grating couplers; and
at least one detection element disposed within the at least one waveguide.

33. The photonic biosensor apparatus of claim 32, wherein the at least one photonic integrated circuit is (a) optically coupled through the substrate, or (b) is connected to the substrate using at least one of a UV curable adhesive, physical stacking, lamination or a tape/glue application.

34. The photonic biosensor apparatus of claim 32, further comprising:
at least one optical input port disposed within the sample detection zone, wherein the optical input port is configured to optically couple to the light source; and
at least one optical output port disposed within the sample detection zone, wherein the optical output port is configured to optically couple to a photodetector via a fiber bundle;
wherein the at least one first grating coupler is aligned with the optical input port, and the at least two second grating couplers are aligned with the optical output port.

35. The photonic biosensor apparatus of claim 32, wherein the fiber bundle includes a plurality of individual fibers, and wherein each of the at least one second grating coupler is mapped to an individual fiber of the fiber bundle.

36. The photonic biosensor apparatus of claim 35, wherein at least one of the individual fibers of the fiber bundle comprises a multimode fiber or a singlemode fiber.

37. The photonic biosensor apparatus of claim 35, wherein the individual fibers of the fiber bundle are positioned in a hexagonal close-packing configuration or in a square close-packing configuration.

38. The photonic biosensor apparatus of claim 32, wherein (a) the at least one photonic integrated circuit is configured for front-side coupling, wherein the at least one photonic integrated circuit configured for front-side coupling is coupled to a top surface of the substrate opposite the fiber bundle or (b) the at least one photonic integrated circuit is configured for back-side coupling, wherein the at least one photonic integrated circuit configured for back-side coupling is coupled to a bottom surface of the substrate between the substrate and the fiber bundle.

39. The photonic biosensor apparatus of claim 32, wherein the photonic biosensor apparatus is configured to detect three or more analytes simultaneously.

40. The photonic biosensor apparatus of claim 32, wherein the substrate comprises at least one of a cassette, a slide, a membrane, a fibrous substrate, or a test card.

41. The photonic biosensor apparatus of claim 32, wherein the light source and the photodetector are included within a read head of at least one of a laboratory analyzer or a point-of-care analyzer.

42. The photonic biosensor apparatus of claim 32, further comprising at least one of a fluid pathway, a paper pathway, or a membrane pathway that fluidly couples the sample addition zone, the sample detection zone, and the wicking zone,

43. The photonic biosensor apparatus of claim 42, wherein the fluid pathway includes micropillars or projections that are substantially vertical to the surface of the substrate and having a height between about 1 μm to 1000 μm, a diameter between about 10 μm to 100 μm, and a reciprocal spacing between the micropillars between about 5 μm to 100 μm such that lateral capillary flow of a fluid sample is achieved.

44. The photonic biosensor apparatus of claim 32, wherein the sample detection zone is configured to provide at least one of fluorescence, refractive index shift, Raman signal, absorbance signal, plasmonic shift or colorimetric detection of one or more analytes within a fluid sample.

45. A photonic integrated circuit, comprising:
at least one first grating coupler;
at least two second grating couplers;
at least one waveguide between the first grating coupler and the second grating couplers; and
at least one detection element disposed within the at least one waveguide.

46. The photonic integrated circuit of claim 45, wherein the at least one detection element includes at least one capture molecule, and wherein the at least one detection element includes at least one of a ring resonator, a double ring resonator, a cylindrical resonator, a spherical resonator, a spiral waveguide, a Vernier filter, a photonic crystal, and a Mach-Zehnder Interferometer.

47. The photonic integrated circuit of claim 45, wherein each detection element of the at least one detection element has a unique extinction ratio.

48. The photonic integrated circuit of claim 45, wherein the at least one first grating coupler is aligned with an optical input port, and the at least two second grating couplers are aligned with an optical output port.

49. The photonic integrated circuit of claim 45, wherein the at least one waveguide comprises a silicon nitride waveguide.

50. The photonic integrated circuit of claim 45, wherein the photonic integrated circuit has a rectangular prism or cuboid shape with a length between 2-20 mm, a width between 0.25-10 mm, and a height between 0.1-5 mm.

51. The photonic integrated circuit of claim 45, wherein the at least one waveguide splits into a plurality of branches from the first grating coupler to the at least two second grating couplers.

52. The photonic integrated circuit of claim 51, wherein the at least one detection element is positioned on one of the plurality of branches.

53. The photonic integrated circuit of claim 45, wherein the at least one detection element has an extinction ratio greater than 5 dB under aqueous cladding.

54. A substrate, comprising:
a sample addition zone in fluid communication with a wicking zone and a sample detection zone, wherein the sample detection zone is between the sample addition zone and the wicking zone; and
at least one photonic integrated circuit disposed directly on a top or bottom surface of the substrate, optically coupled to a light source and a photodetector via a fiber bundle, wherein the at least one photonic integrated circuit comprises:
at least one first grating coupler;
at least one second grating coupler;
at least one waveguide between the first grating coupler and the second grating coupler; and
at least one detection element disposed within the at least one waveguide.

55. The substrate of claim 54, wherein the at least one detection element is positioned to contact a fluid sample within the sample detection zone.

56. The substrate of claim 54, wherein the at least one photonic integrated circuit is optically coupled through the substrate.

57. The substrate of claim 54, further comprising:
at least one optical input port disposed within the sample detection zone, wherein the optical input port is configured to optically couple to a light source; and
at least one optical output port disposed within the sample detection zone, wherein the optical output port is configured to optically couple to a photodetector via a fiber bundle;
wherein the at least one first grating coupler is aligned with the optical input port, and the at least two second grating couplers are aligned with the optical output port.
